(19) United States
(12) Patent Application Publication
(10) Pub. No.: US 2008/0030580 A1
(43) Pub. Date: Feb. 7, 2008

(54) Command system, imaging device, command device, imaging method, command processing method, and program

(76) Inventors: Kotaro Kashiwa, Kanagawa (JP); Mitsutoshi Shinkai, Kanagawa (JP)

Correspondence Address: FROMMER LAWRENCE & HAUG LLP, 745 FIFTH AVENUE, NEW YORK, NY, 10151, US

(21) Appl. No.: 11/706,124

(22) Filed: Feb. 14, 2007

(30) Foreign Application Priority Data
Feb. 15, 2006 (JP) P2006-037941

(51) Int. Cl. H04N 7/18; G06K 9/00

(52) U.S. Cl. 348/158; 382/115; 348/E07.001; 348/E07.085; 348/E07.087

(57) ABSTRACT

A command system includes: a portable imaging device; and a command device configured to communicate with the imaging device. The imaging device includes: an imaging unit; a communication unit; a characteristic data setting unit; a target image detecting unit; a recording unit; and an imaging process control unit, and the command device includes: a communication unit; and a characteristic setting information generating unit.

### CROSS REFERENCES TO RELATED APPLICATIONS

The present invention contains subject matter related to Japanese Patent Application JP 2006-037941 filed in the Japanese Patent Office on Feb. 15, 2006, the entire contents of which being incorporated herein by reference.

### BACKGROUND OF THE INVENTION

1. Field of the Invention

The present invention relates to an imaging device, a command device, and a command system having an imaging device and a command device communicating with each other provided therein. In addition, the invention relates to an imaging method of an imaging device, a command processing method of a command device, and a program for realizing the functions of the command device and the imaging device.

2. Description of the Related Art

Examples of the related art of the invention include JP-A-2003-274358, JP-A-2003-274359, JP-A-2003-274360, and JP-A-2004-180279.

In a police organization, security companies, or detective companies, it is an important job to search a person or pay attention to a person. For example, it is an important job to search a wanted criminal, a missing person, a fugitive criminal, a runaway car, and an article.

### SUMMARY OF THE INVENTION

For example, when a policeman searches a person or an article on patrol, the related art has the following problems.

For example, when the police headquarters instruct a policeman on patrol to search a fugitive criminal or a runaway car, the police headquarters wirelessly transmit the characteristic of the person or the car. For example, ‘a thirty-year-old man wearing red clothes’ or ‘a white wagon’ is included in the characteristic of the person or the car.

However, such characteristics are vague, and generally, there are many persons wearing the same color clothes or many cars having the same color.

When a plurality of characters of a person are transmitted to the policeman or the characteristics of a plurality of persons are transmitted to the policeman, it is difficult for the policeman to accurately remember these characteristics.

In this case, even when the policeman on patrol encounters a person or a car to be searched, the policeman may not recognize the person and let the person get away. In particular, the policeman should take various actions for security of a district assigned to the policeman, in addition to search for a designated object, which makes it difficult for the policeman to concentrate on search for the designated object.

Meanwhile, a technique has been proposed in which a camera device is attached to a policeman on patrol and automatically captures moving pictures or still pictures at predetermined time intervals to collect information on a district assigned to the policeman, and the policeman reproduces the captured images later.

However, it is an inefficient work to reproduce a large number of still pictures or the moving pictures captured by the policeman on patrol for a long time and to check the reproduced images. That is, the policeman should view all the images, which requires much time and a high degree of concentration. In this case, there is a fear that the policeman may overlook the image of a person or a car corresponding to the characteristic of an object to be searched.

Accordingly, it is desirable to provide a technique for accurately and effectively searching a person or an article on the basis of the characteristic thereof, or accurately and effectively checking the image of the person or the article.

According to an embodiment of the invention, a command system includes a portable imaging device and a command device configured to communicate with the imaging device. The imaging device includes: an imaging unit configured to perform image capture to acquire image data; a communication unit configured to communicate with the command device; a characteristic data setting unit configured to set characteristic data on the basis of characteristic setting information transmitted from the command device; a target image detecting unit configured to analyze the image data acquired by the imaging unit and detect target image data corresponding to the set characteristic data; a recording unit configured to record the image data acquired by the imaging unit on a recording medium; and an imaging process control unit configured, when the target image data is detected by the target image detecting unit, to record mark information for identifying the target image data among the image data recorded by the recording unit.

In the above-mentioned embodiment, preferably, the imaging device further includes a presentation unit configured to present information, and the characteristic data setting unit controls the presentation unit to present the content of the characteristic data set on the basis of the characteristic setting information.

In the imaging device according the above-mentioned embodiment, preferably, the characteristic data is data indicating the characteristic of an article or a person in appearance, data indicating the movement of the article or the person, or data indicating a specific sound.

In the above-mentioned embodiment, preferably, the imaging device further includes a sound input unit. In addition, preferably, the target image detecting unit analyzes audio data obtained by the sound input unit. When audio data corresponding to the set characteristic data is detected, the target image detecting unit detects the target image data, considering as the target image data the image data obtained by the imaging unit at the timing at which the audio data is input.

In the imaging device according to the above-mentioned embodiment, preferably, when the target image data is detected by the target image data detecting unit, the imaging process control unit generates target detection notice information and controls the communication unit to transmit the target detection notice information to the command device.

In the imaging device according to the above-mentioned embodiment, preferably, the target detection notice information includes the target image data.

According to the above-mentioned embodiment, preferably, the imaging device further includes a position detecting unit configured to detect positional information, and the target detection notice information includes the positional information detected by the position detecting unit.

According to the above-mentioned embodiment, preferably, the imaging device further includes a display unit configured to display information. In this case, when the target image data is detected by the target image detecting unit, the imaging process control unit controls the display unit to display an image composed of the target image data.

In the imaging device according to the above-mentioned embodiment, preferably, the imaging process control unit controls the recording unit to start recording the image data in a first recording mode. In addition, when the target image data is detected by the target image detecting unit, the imaging process control unit controls the recording unit to record the image data in a second recording mode.

According to the above-mentioned embodiment, preferably, the imaging device further includes: a presentation unit configured to present information; and a command information processing unit configured, when the communication unit receives command information from the command device, to control the presentation unit to present the content of the command information.

According to the above-mentioned embodiment, preferably, the imaging device further includes a setting cancellation processing unit configured, when the communication unit receives setting cancellation information from the command device, to cancel the setting of the characteristic data indicated by the setting cancellation information.

According to the above-mentioned embodiment, preferably, the imaging device further includes: a reproduction unit configured to reproduce the image data recorded on the recording medium; and a mark image reproduction control unit configured to control the reproduction unit to reproduce the image data, serving as the target image data, on the basis of the mark information.

In the command system, the command device includes: a communication unit configured to communicate with the imaging device; and a characteristic setting information generating unit configured to generate characteristic setting information for setting characteristic data and control the communication unit to transmit the characteristic setting information to the imaging device.

In the command device according to the above-mentioned embodiment, preferably, the characteristic data is data indicating the characteristic of an article or a person in appearance, data indicating the movement of the article or the person, or data indicating a specific sound.

According to the above-mentioned embodiment, preferably, the command device further includes: a presentation unit configured to present information; and a target detection notice correspondence processing unit configured, when the communication unit receives target detection notice information from the imaging device, to control the presentation unit to present information included in the received target detection notice information.

According to the above-mentioned embodiment, preferably, the command device further includes: a command processing unit configured to generate command information and control the communication unit to transmit the command information to the imaging device.

According to the above-mentioned embodiment, preferably, the command device further includes a setting cancellation instructing unit configured to generate setting cancellation information for canceling the characteristic data set in the imaging device and to control the communication unit to transmit the setting cancellation information to the imaging device.

According to the above-mentioned embodiment, preferably, the command device further includes: a reproduction unit configured to reproduce a recording medium having image data and mark information for identifying target image data of the image data recorded thereon in the imaging device; and a mark image reproduction control unit configured to control the reproduction unit to reproduce the image data, serving as the target image data, on the basis of the mark information.

According to another embodiment of the invention, there is provided an imaging method of a portable imaging device that is configured to communicate with a command device. The method includes the steps of: setting characteristic data on the basis of characteristic setting information transmitted from the command device; performing image capture to acquire image data; recording the acquired image data on a recording medium; analyzing the acquired image data to detect target image data corresponding to the set characteristic data; and when the target image data is detected, recording mark information for identifying the target image data among the recorded image data.

According to the above-mentioned embodiment, preferably, the imaging method further includes: when the target image data is detected, generating target detection notice information and transmitting the target detection notice information to the command device.

According to the above-mentioned embodiment, preferably, the imaging method further includes: when command information is received from the command device, presenting the content of the command information.

According to still another embodiment of the invention, there is provided a command processing method of a command device that is configured to communicate with an imaging device. The method includes the steps of: generating characteristic setting information for setting characteristic data and transmitting the characteristic setting information to the imaging device; when target detection notice information is received from the imaging device, presenting information included in the received target detection notice information; and generating command information and transmitting the command information to the imaging device.

According to yet another embodiment of the invention, there are provided a program for executing the imaging method of the imaging device and a program for executing the command processing method of the command device.

In the above-mentioned embodiments of the invention, for example, a policeman having an imaging device makes his rounds of inspection. The imaging device captures moving pictures or still pictures at a predetermined time interval and records image data.

Characteristic data for an object (target) is set to the imaging device on the basis of characteristic setting information transmitted from the command device. The imaging device analyzes the captured image data and detects target image data corresponding to the set characteristic data.

When the target image data is detected, the imaging device records mark information for identifying the target image data among the recorded image data. The mark information is information indicating the recording position (for example, an address on a recording medium) of the target image data. When the recording medium is reproduced, the mark information makes it possible to select the target image data and reproduce the selected target image data.

When the target image data is detected, target detection notice information including, for example, the target image data or current position information is transmitted to the command device. Then, the command device checks the content of the target detection notice information and issues a command to the policeman. That is, command information is transmitted from the command device to the imaging device. The imaging device represents the content of the command information to the user, i.e., the policeman.

According to the above-mentioned embodiments of the invention, characteristic data for a person or an article to be searched is set to the imaging device according to commands from the command device.

Therefore, the command device can transmit characteristic setting information to a plurality of imaging devices and collect information from each of the imaging devices, if needed. The user, such as the policeman, of the imaging device does not need to manually set characteristic data. In addition, since the captured image or target detection notice information is automatically transmitted to the command device, the operation of the system is simplified, and thus the policeman on patrol can easily use the imaging device.

In addition, it is possible to detect a person or an article to be searched using target image data of a captured image, without depending on only the memory or attentiveness of a policeman on the spot.

Further, since target image data is marked by the mark information, it is possible to effectively check the captured images during reproduction.

When target image data is detected, the image or positional information is transmitted to the command device provided in the police headquarters. Therefore, the command system is suitable to check an object to be searched or to command policemen.

By checking information presented (displayed) according to the content of set characteristic data, the detection of a target, and the reception of a command, the policeman can take appropriate actions.

When receiving setting cancellation information from the command device, the imaging device cancels the setting of the characteristic data. That is, the command device can instruct the imaging device to cancel the setting of characteristic data when a case is settled or search for a person or an article ends. Therefore, the policeman using the imaging device does not need to perform a setting cancellation operation and can cancel the setting of characteristic data at an appropriate time, which results in a simple detection process.

Therefore, according to the above-mentioned embodiments of the invention, the command system, the imaging device, and the command device are very useful to search a person or an article.

### BRIEF DESCRIPTION OF THE DRAWINGS

FIG. 1 is a diagram illustrating a command system according to an embodiment of the invention;

FIG. 2 is a diagram illustrating the appearance of an imaging device according to the embodiment of the invention;

FIG. 3 is a diagram illustrating the usage of the imaging device according to the embodiment of the invention;

FIG. 4 is a diagram illustrating viewing angles of the imaging device according to the embodiment of the invention;

FIG. 5 is a block diagram illustrating the structure of the imaging device according to the embodiment of the invention;

FIG. 6 is a block diagram illustrating the structure of a computer system for realizing a command device according to the embodiment of the invention;

FIG. 7A is a block diagram illustrating the functional structure of the imaging device according to the embodiment of the invention;

FIG. 7B is a block diagram illustrating the functional structure of the command device according to the embodiment of the invention;

FIG. 8 is a flowchart illustrating a process of setting characteristic data according to the embodiment of the invention;

FIG. 9 is a diagram illustrating characteristic setting information according to the embodiment of the invention;

FIG. 10 is a diagram illustrating the setting of the characteristic data according to the embodiment of the invention;

FIG. 11 is a diagram illustrating an example of display when the characteristic data is set according to the embodiment of the invention;

FIG. 12 is a flow chart illustrating the process of the imaging device capturing an image according to the embodiment of the invention;

FIGS. 13A to 13C are diagrams illustrating a recording operation of the imaging device according to the embodiment of the invention;

FIG. 14 is a diagram illustrating a mark file according to the embodiment of the invention;

FIG. 15 is a diagram illustrating an example of display when target image data is detected according to the embodiment of the invention;

FIG. 16 is a diagram illustrating target detection notice information according to the embodiment of the invention;

FIG. 17 is a flowchart illustrating a command process of the command device according to the embodiment of the invention;

FIG. 18 is a flowchart illustrating a command information receiving process of the imaging device according to the embodiment of the invention;

FIG. 19A is a diagram illustrating command information according to the embodiment of the invention;

FIG. 19B is a diagram illustrating setting cancellation information according to the embodiment of the invention;

FIG. 20A is a diagram illustrating an example of displayed command information according to the embodiment of the invention;

FIG. 20B is a diagram illustrating an example of displayed setting cancellation information according to the embodiment of the invention;

FIG. 21 is a flowchart illustrating a setting cancellation process according to the embodiment of the invention;

FIG. 22 is a flowchart illustrating a reproduction process according to the embodiment of the invention; and

FIG. 23 is a diagram illustrating a displayed mark list during reproduction according to the embodiment of the invention.

### DESCRIPTION OF THE PREFERRED EMBODIMENTS

Hereinafter, an exemplary embodiment of the invention will be described in the following order:

1. Schematic structure of command system

2. Structure of imaging device

3. Structure of command device

4. Process of setting characteristic data

5. Process when imaging device captures images

6. Command process of command device

7. Process when imaging device receives command information

8. Process of canceling setting of characteristic data

9. Reproducing process

10. Effects of the invention and modifications thereof.

1. Schematic Structure of Command System

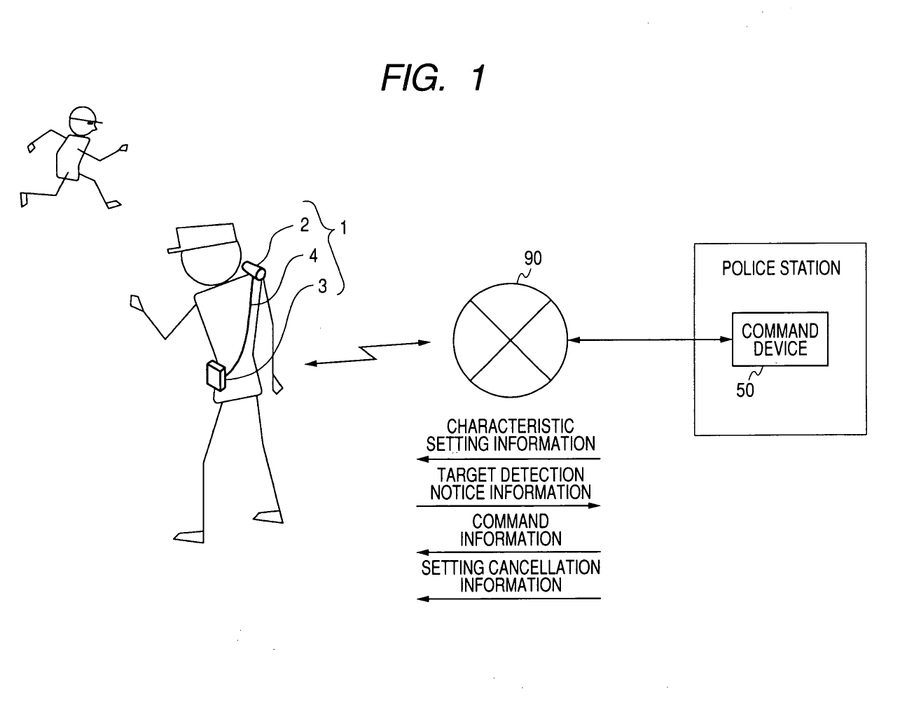

FIG. 1 is a diagram illustrating an inquiry system according to an embodiment of the invention. In this embodiment, a command system is given as an example of a system that is used for the guard and police, in particular, for searching for fugitive criminals, wanted criminals, or missing persons.

The command system according to this embodiment includes an imaging device 1 attached to a policeman on patrol and a command device 50 used in, for example, police headquarters.

The imaging device 1 includes a camera unit 2 and a control unit 3 that is separately provided from the camera unit 2. The camera unit 2 and the control unit 3 are connected to each other such that signals can be transmitted therebetween through a cable 4.

As shown in FIG. 1, the camera unit 2 is attached to the shoulder of a user. The control unit 3 is attached to the waist of the user or is held in the pocket of the user. That is, the imaging device 1 is attached such that the user can take a photograph without using his hand.

The imaging device 1 (control unit 3) can communicate with the command device 50 through a network 90.

A public network, such as the Internet or a mobile telephone network, may be used as the network 90. It is assumed that a dedicated network is constructed for the police.

FIG. 1 shows the imaging device 1 attached to a policeman. However, actually, the imaging devices 1 are attached to a large number of policemen. In this case, each of the imaging devices 1 can communicate with the command device 50 through the network 90.

The command device 50 sets characteristic data indicating the characteristic of an article or a person to be searched (object) to the imaging device 1, which will be described later, or transmits a command to a policeman, which is a user of the imaging device 1 on the basis of information received from the imaging device 1.

The command system operates as follows.

As shown in FIG. 1, a policeman on patrol wears the imaging device 1.

First, characteristic data for a person or an article to be searched is set to the imaging device 1 on the basis of characteristic setting information from the command device 50. The characteristic data is data indicating characteristics of a person or an article in appearance. For example, the characteristic data is data indicating the color of an object, for example, ‘a person in green cloths’ or ‘a white wagon’. In addition, the characteristic data may be data indicating the operation of a person or an article, such as ‘a running person’ or ‘a car traveling in zigzag’, or data indicating a specific voice, such as a specific keyword or sound.

The imaging device 1 captures moving pictures or still pictures at predetermined intervals and stores image data in a storage medium provided therein. In this case, the imaging device 1 analyzes an image corresponding to image data acquired from a capturing operation and determines whether the analyzed image corresponds to the set characteristic data. For the purpose of convenience of explanation, the image corresponding to the characteristic data is referred to as ‘target image data’.

When the target image data is detected, the imaging device 1 records mark information for identifying the target image data among the stored image data. For example, an address to which the target image data is recorded is stored as a mark file, which will be described later.

Further, when the target image data is detected, the imaging device 1 transmits, for example, the target image data or target detection notice information including current position information to the command device 50.

The command device 50 displays the content of the target detection notice information such that staffs of the police headquarters can view the content.

When a commander of the headquarters issues a command to a policeman wearing the imaging device 1, the command device 50 transmits command information to the imaging device 1. The imaging device 1 having received the command information notifies the content of the command information to the policeman wearing the imaging device 1 (for example, the imaging device 1 displays the content).

In this embodiment, for example, it is assumed that data indicating ‘a running person’ is set as the characteristic data, and as shown in FIG. 1, a policeman on patrol encounters a running person. In this case, when the imaging device 1 captures the image of the running person, the recording position of image data is marked, and the imaging device 1 transmits target detection notice information to the command device 50.

The command device 50 displays positional information or target image data included in the target detection notice information to the staffs of the headquarters. When it is reliably determined that the person displayed on the basis of the target image data is a fugitive criminal, the command device 50 transmits command information to the imaging device 1. For example, a command to arrest the criminal is transmitted. When the content of the command information is output from the imaging device 1 in the form of an image or a sound, the policeman can start arresting the criminal according to the command from the headquarters.

Even when the policeman cannot cope with this situation, it is possible to check whether a wanted criminal is at that place later by reproducing the image that has been captured and stored at the time of patrol. In this case, since mark information is stored to correspond to the recorded target image data, it is possible to extract the moving picture of a person or an article corresponding to characteristic data and reproduce the extracted moving picture.

The command device 50 can cancel the setting of the characteristic data to each of the imaging devices 1. That is, when the command device 50 transmits setting cancellation information to the imaging device 1, the imaging device 1 cancels the setting of specific characteristic data on the basis of the setting cancellation information. When the setting of the characteristic data is canceled, the characteristic data is used to detect target image data by image analysis.

2. Structure of Imaging Device

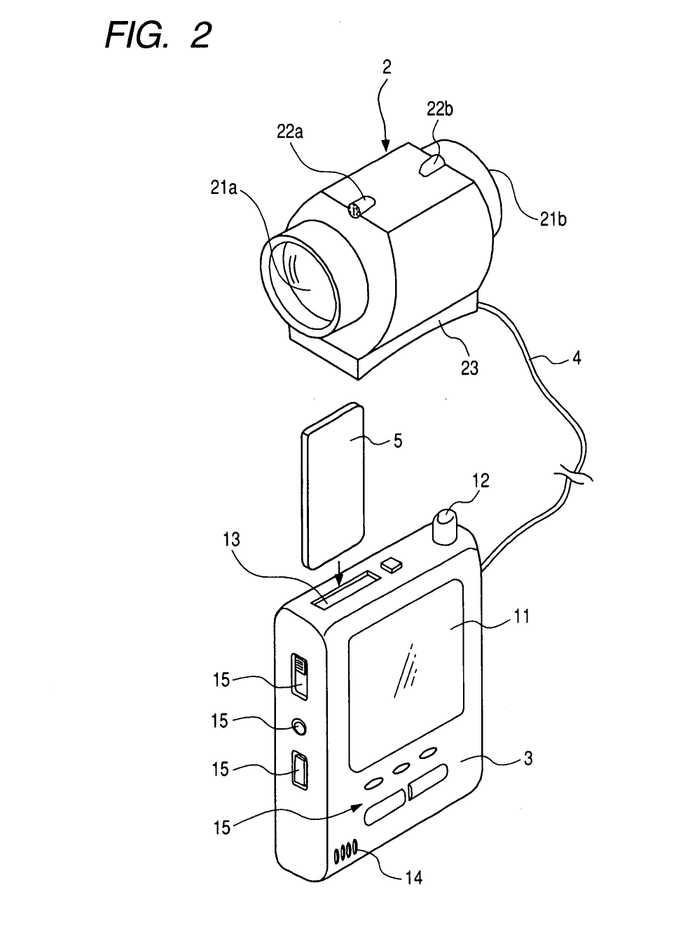

FIG. 2 is a diagram illustrating the appearance of the imaging device 1 according to this embodiment.

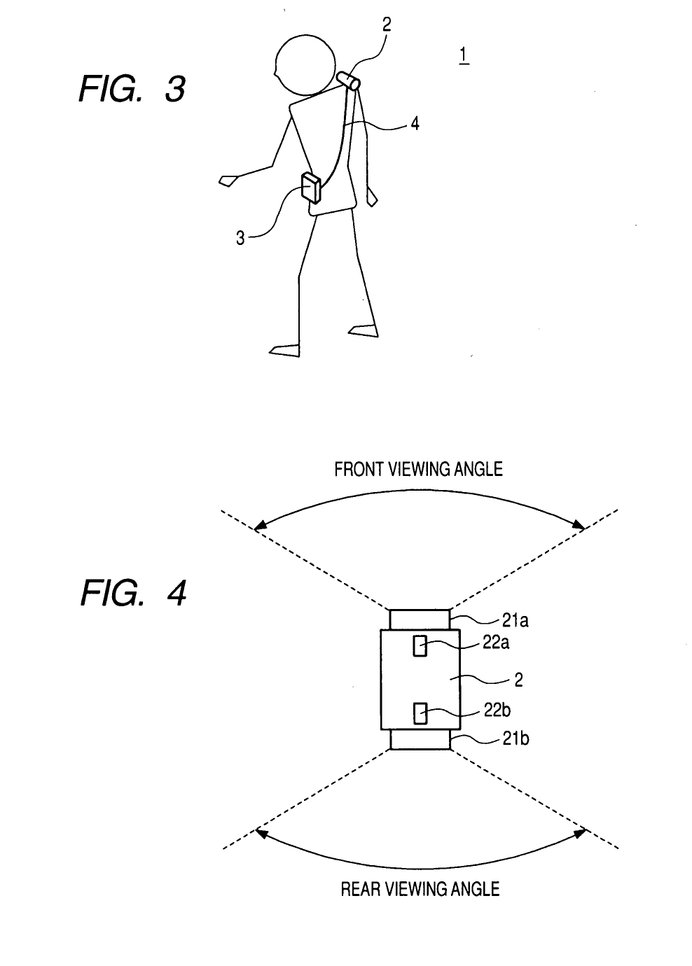

As described above, the imaging device 1 includes the camera unit 2, the control unit 3, and the cable 4 for connecting the camera unit 2 and the control unit 3 such that they can communicate with each other. As shown in FIG. 3, the camera unit 2 is attached to the shoulder of a user, and the control unit 3 is attached to the waist of the user or is held in the pocket thereof.

The camera unit 2 is attached to the shoulder of the user by various manners. Although not described in detail in this embodiment, a member for holding a seating base 23 for the camera unit 2 may be attached to the clothes of the user (for example, a jacket of a policeman), or the camera unit 2 may be attached to the shoulder of the user through an attaching belt.

For example, the camera unit 2 may be fixed to the top or side of the helmet of the user or attached to the chest or arm of the user. However, since the shoulder of the user has the smallest amount of movement while the user is walking, it is most suitable to attach the camera unit 2 for capturing an image to the shoulder of the user.

As shown in FIG. 2, the camera unit 2 is provided with two camera portions, that is, a front camera portion 21a and a rear camera portion 21b, and front and rear microphones 22a and 22b corresponding to the front and rear camera portions 21a and 21b.

The front camera portion 21a captures the image of a scene in front of the user while being attached to the user as shown in FIG. 3, and the rear camera portion 21b captures the image of a scene in the rear of the user.

Each of the front camera unit 21a and the rear camera unit 21b is equipped with a wide-angle lens which has a relatively wide viewing angle as shown in FIG. 4. The front camera unit 21a and the rear camera unit 21b capture the images of almost all objects surrounding the user.

The front microphone 22a has high directionality in the front direction of the user in the state shown in FIG. 3, and collects a sound corresponding to the image captured by the front camera portion 21a.

The rear microphone 22b has high directionality in the rear direction of the user in the state shown in FIG. 3, and collects a sound corresponding to the image captured by the rear camera portion 21b.

It goes without saying that the front viewing angle and the rear viewing angle, which are image capture ranges of the front camera portion 21a and the rear camera portion 21b, depend on the design of a lens system used. The front and rear viewing angles may be set according to the usage environment of the imaging device 1. Of course, the front viewing angel is not necessarily to equal to the rear viewing angle, and the viewing angles may be set to be narrow according to the types of camera devices.

The directivity of the front microphone 22a is equal to that of the rear microphone 22b, but the directivities of the microphones may vary according to the purpose of use. For example, one non-directional microphone may be provided.

The control unit 3 has a function of recording video signals (and audio signal) captured by the camera unit 2 on a memory card 5, a function of performing data communication with the command device 50, and a user interface function, such as a display and operation function.

For example, a display unit 11 composed of, for example, a liquid crystal panel is provided in the front surface of the control unit 3.

A communication antenna 12 is provided at a predetermined position in the control unit 3.

In addition, the control unit 3 is provided with a card slot 13 for mounting the memory card 5.

Further, the control unit 3 is provided with a sound output unit (speaker) 14 for outputting an electronic sound and a voice.

The control unit 3 may be provided with a headphone terminal (not shown) or a cable connection terminal (not shown) used to transmit/receive data to/from an information apparatus according to a predetermined transmission protocol, such as USB or IEEE 1394.

Various keys or slide switches are provided as an operating unit 15 that the user operates. Alternatively, an operator, such as a jog dial or a trackball, may be provided.

The operation unit 15 includes, for example, a cursor key, an enter key, and a cancel key, and moves a cursor on a screen of the display unit 11 to perform various input operations. The operating unit 15 may be provided with dedicated keys for basic operations, as well as dedicated keys for starting or stopping image capture, setting a mode, and turning on or off power.

For example, the user can wear the imaging device 1 including the camera unit 2 and the control unit 3, as shown in FIG. 3, to unconsciously capture an image in a hand-free manner. Therefore, the imaging device 1 enables a guard or a policeman to take a picture while doing other jobs or to take a picture on patrol.

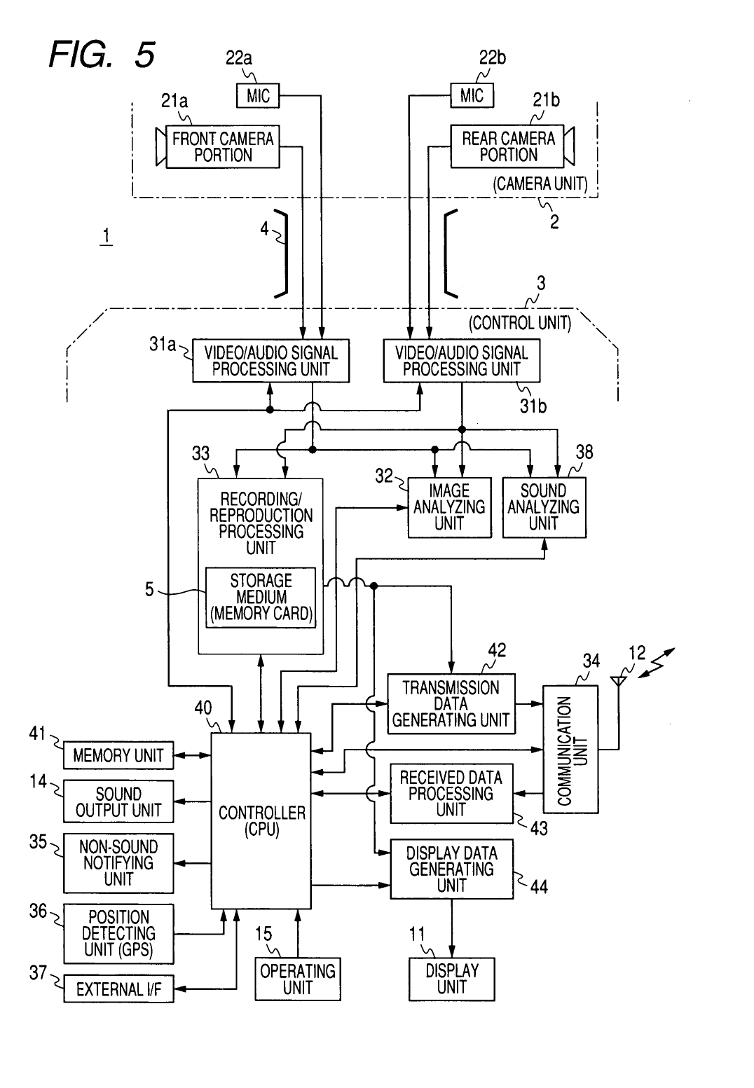

FIG. 5 is a diagram illustrating an example of the internal structure of the imaging device 1.

As described above, the camera unit 2 is provided with the front camera portion 21a and the rear camera portion 21b. Each of the front camera portion 21a and the rear camera portion 21b is provided with an imaging optical lens system, a lens driving system, and an imaging element, such as a CCD or a CMOS.

Imaging light captured by the front camera unit 21a and the rear camera unit 21b is converted into video signals by the imaging elements provided therein, and predetermined signal processing, such as gain adjustment, is performed on the video signals. Then, the processed signals are transmitted to the control unit 3 through the cable 4.

Audio signals acquired by the front microphone 22a and the rear microphone 22b are also transmitted to the control unit 3 through the cable 4.

The control unit 3 includes a controller (CPU: central processing unit) 40 which controls the operations of all components. The controller 40 controls an operating program or all the components in response to operation signals input through the operating unit 15 from the user in order to perform various operations, which will be described later.

A memory unit 41 is a storage unit that stores program codes executed by the controller 40 and temporarily stores operational data being executed. For example, the memory unit 41 has a characteristic data setting region for storing characteristic data set by the command device 50.

As shown in FIG. 5, the memory unit 41 includes both a volatile memory and a non-volatile memory. For example, the memory unit 41 includes non-volatile memories, such as a ROM (read only memory) for storing programs, a RAM (random access memory) for temporarily storing, for example, an arithmetic work area, and an EEP-ROM (electrical erasable and programmable read only memory).

The video signals transmitted from the front camera portion 21a of the camera unit 2 through the cable 4 and the audio signals transmitted from the front microphone 22a through the cable 4 are input to a video/audio signal processing unit 31a.

The video signals transmitted from the rear camera portion 2b and the audio signals transmitted from the rear microphone 3b are input to a video/audio signal processing unit 31b.

Each of the video/audio signal processing units 31a and 31b performs video signal processing (for example, bright processing, color processing, and correction) and audio signal processing (for example, equalizing and level adjustment) on the input video/audio signals to generate video data and audio data as the signals captured by the camera unit 2.

In the image capturing operation, for example, in a moving picture capturing operation, a series of frames of images may be captured at a predetermined frame rate, or video data for one frame may be sequentially captured at a predetermined time interval to continuously capture still pictures.

The video data processed by the video/audio signal processing units 31a and 31b is supplied to an image analyzing unit 32 and a recording/reproduction processing unit 33.

The audio data processed by the video/audio signal processing units 31a and 31b is supplied to the sound analyzing unit 38 and the recording/reproduction processing unit 33.

When a moving picture is captured, frame data of the video data processed by the video/audio signal processing units 31a and 31b is sequentially supplied to the recording/reproduction processing unit 33 and the image analyzing unit 32. Then, the recording/reproduction processing unit 33 records the moving picture, and the image analyzing unit 32 analyzes the moving picture.

The audio data may be recorded at the same time. In this case, two types of video data, that is, the video data captured by the front camera portion 21a and the video data captured by the rear camera portion 21b may be recorded, or the video data captured by the front camera portion 21a and the video data captured by the rear camera portion 21b may be alternately recorded at predetermined time intervals.

When still pictures are captured at predetermined time intervals, the video data processed by the video/audio signal processing units 31a and 31b at a predetermined time interval (for example, at a time interval of 1 to several seconds) is supplied to the recording/reproduction processing unit 33 and the image analyzing unit 32. Then, the recording/reproduction processing unit 33 records the still pictures at predetermined time intervals, and the image analyzing unit 32 analyzes the still pictures. In this case, it is considered that the video data captured by the front camera portion 21a and the video data captured by the rear camera portion 21b are alternately supplied to the image analyzing unit 32 at a predetermined time interval. When the still picture is recorded, video data of each frame, which is moving picture data, may be supplied to the image analyzing unit 32 as an object to be analyzed. This is because, for example, when the motion of a person is used as characteristic data, an image analyzing process, such as frame image comparison, is needed.

The image analyzing unit 32 analyzes the video data that has been processed by the video/audio signal processing units 31a and 31b and then supplied.

For example, the image analyzing unit 32 performs a process of extracting the image of an object, such as a person, a process of analyzing the color of the image, and a process of analyzing the motion of the object, and detects whether the analyzed image is an image corresponding to characteristic data. In this case, various types of characteristic data may be used, and various types of analyzing processes may be used. An analyzing process may be determined according to characteristic data to be set.

The characteristic data set as a target to be detected in the analyzing process performed by the image analyzing unit 32 is notified by the controller 40. The image analyzing unit 32 determines whether the supplied video data corresponds to the notified characteristic data.

When target image data corresponding to the characteristic data is detected, the image analyzing unit 32 supplies the detected information to the controller 40.

A sound analyzing unit 38 analyzes the audio data that has been processed by the video/audio signal processing units 31a and 31b and then supplied. For example, the sound analyzing unit 38 detects whether the sound of a specific keyword or a specific sound (for example, a car engine sound, a siren sound, or the voice of a user) is collected.

The characteristic data set as a target to be detected in the analyzing process performed by the sound analyzing unit 38 is notified by the controller 40. The sound analyzing unit 38 determines whether the supplied audio data corresponds to the notified characteristic data.

When a sound corresponding to the characteristic data is detected, the audio analyzing unit 38 supplies the detected information to the controller 40. The controller 40 determines that video data at the input timing of the sound is target image data.

The recording/reproduction processing unit 33 records the video data that has been processed by the video/audio signal processing units 31a and 31b and then supplied to a recording medium (the memory card 5 inserted into a memory card slot 13 shown in FIG. 1) as an image file, or it reads out the image file recorded onto the memory card 5, under the control of the controller 40.

The recording/reproduction processing unit 33 compresses the video data in a predetermined compression format at the time of recording, or performs encoding in a recording format used to record to the video data on the memory card 5.

The recording/reproduction processing unit 33 extracts various information items from the recorded image file or decodes the image at the time of reproduction.

The recording/reproduction processing unit 33 records and updates a mark file according to an instruction from the controller 40. That is, when the controller 40 determines that the target image data is detected on the basis of the analysis result of the image analyzing unit 32 or the sound analyzing unit 38, the controller 40 instructs the recording/reproduction processing unit 33 to generate mark information on the image data (or image data at the timing corresponding to the detected sound), which is an object to be analyzed. The recording/reproduction processing unit 33 generates mark information including information on the recording position of the target image data in the memory card 5, and writes the generated information to a mark file. Then, the recording/reproduction processing unit 33 records the mark file on the memory card 5.

A transmission data generating unit 42 generates a data packet to be transmitted to the command device 50. That is, the transmission data generating unit 42 generates a data packet serving as target detection notice information. The target detection notice information includes image data that is determined as target image data on the basis of the result detected by the image analyzing unit 32 or the sound analyzing unit 38, positional information acquired by a position detecting unit 36, which will be described later, and date and time information.

The transmission data generating unit 42 supplies the data packet, serving as the target detection notice information, to a communication unit 34 in order to transmit the data packet.

The communication unit 34 transmits the data packet to the command device 50 through the network 90.

The communication unit 34 performs a predetermined modulating process or an amplifying process on the data detection notice information generated by the transmission data generating unit 42, and then wirelessly transmits data detection notice information from an antenna 12.

Further, the communication unit 34 receives information, that is, characteristic setting information, command information, and setting cancellation information, from the command device 50 and demodulates the information. Then, the communication unit 34 supplies the received data to a received data processing unit 43.

The received data processing unit 43 performs predetermined processes, such as buffering, packet decoding, and information extraction, on the data received from the communication unit 34 and supplies the content of received data to the controller 40.

A display data generating unit 44 generates display data to be displayed on the display unit 11 according to instructions from the controller 40.

When characteristic setting information, command information, and setting cancellation information are transmitted from the command device 50, the controller 40 instructs the display data generating unit 44 to generate display data indicating an image or characters to be displayed on the transmitted information items. Then, the display data generating unit 44 drives the display unit 11 to display an image, on the basis of the generated display data.

Although a signal path is not shown in FIG. 5, the display data generating unit 44 performs processes of displaying an operation menu, an operational state, an image reproduced from the memory card 5, and the video signals captured by the front camera portion 21a and the rear camera portion 21b on the monitor according to instructions from the controller 40.

The sound output unit 14 includes an audio signal generating unit that generates an electronic sound or a message sound, an amplifying circuit unit, and a speaker, and outputs a predetermined sound according to instructions from the controller 40. For example, the sound output unit 14 outputs a message sound or an alarm when various operations are performed, or it outputs a sound notifying the user that various information items are received from the command device 50.

Although a signal path is not shown in FIG. 5, when the audio signals collected by the front microphone 22a and the rear microphone 22b are supplied to the sound output unit 14, the sound output unit 14 outputs the sound acquired at the time of image capturing. When the recording/reproduction processing unit 33 performs reproduction, the sound output unit 14 also outputs the reproduced sound.

A non-sound notifying unit 35 notifies the user that information is received from the command device 50 in various forms other than sound according to instructions from the controller 40. For example, the non-sound notifying unit 35 is composed of a vibrator, and notifies to the user (policeman) wearing the imaging device 1 that command information is received from the command device 50 through the vibration of the device.

As described with reference to FIG. 2, the operating unit 15 includes various types of operators provided on the case of the controller 3. For example, the controller 40 controls the display unit 11 to display various operation menus. Then, the user operates the operating unit 15 to move a cursor or pushes an enter key of the operating unit 15 to input information to the imaging device 1. The controller 40 performs predetermined control in response to the input of information through the operating unit 15 by the user. For example, the controller 40 can perform various control processes, such as a process of starting/stopping capturing an image, a process of changing an operational mode, recording and reproduction, and communication, in response to the input of information from the user.

The operation unit 15 may not include operators corresponding to the operation menus on the display unit 11. For example, the operation unit 15 may include an image capture key, a stop key, and a mode key.

A position detecting unit 36 is equipped with a GPS (global positioning system) antenna and a GPS decoder. The position detecting unit 36 receives signals from a GPS satellite, decodes received signals, and outputs the latitude and longitude of the current position, as information on the current position.

The controller 40 can check the current position on the basis of the longitude and latitude data from the position detecting unit 36, and supply the current position information to the transmission data generating unit 42 such that the current position information is included in the data packet as target detection notice information.

An external interface is used for connection to external devices and communication with the external devices. For example, the external interface can perform data communication with the external devices according to a predetermined interface standard, such as USB or IEEE 1394. For example, the external interface makes it possible to perform uploading for the version-up of an operating program of the controller 40, the transmission of data to be reproduced from the memory card 5 to an external device, and the input of various information items from an external device.

The above-mentioned structure enables the imaging device 1 to perform the following various processes. The controller 40 controls an image capturing operation performed by the camera unit 2 and the video/audio signal processing unit 31a and 31b, a recording/reproduction operation performed by the recording/reproduction processing unit 33, an analyzing/detecting operation performed by the image analyzing unit 32 and the sound analyzing unit 38, an operation of generating target detection notice information performed by the transmission data generating unit 42, a communication operation performed by the communication unit 34, a display data generating operation performed by the display data generating unit 44, and the operations of the sound output unit 14 and the non-sound notifying unit.

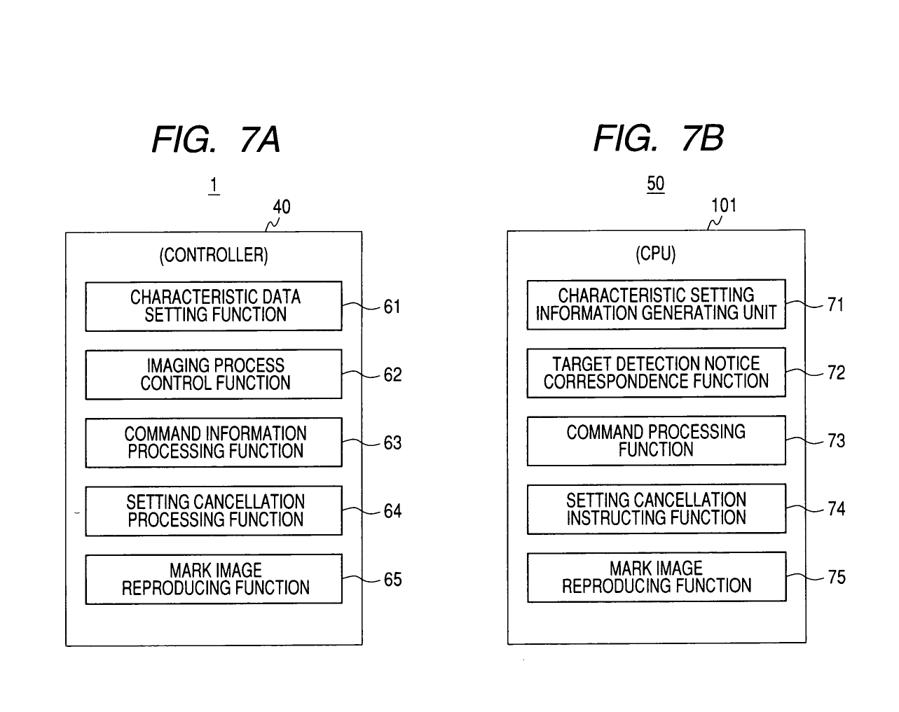

In order to realize the following processes, for example, a software program allows the controller 40 to perform functions shown in FIG. 7A.

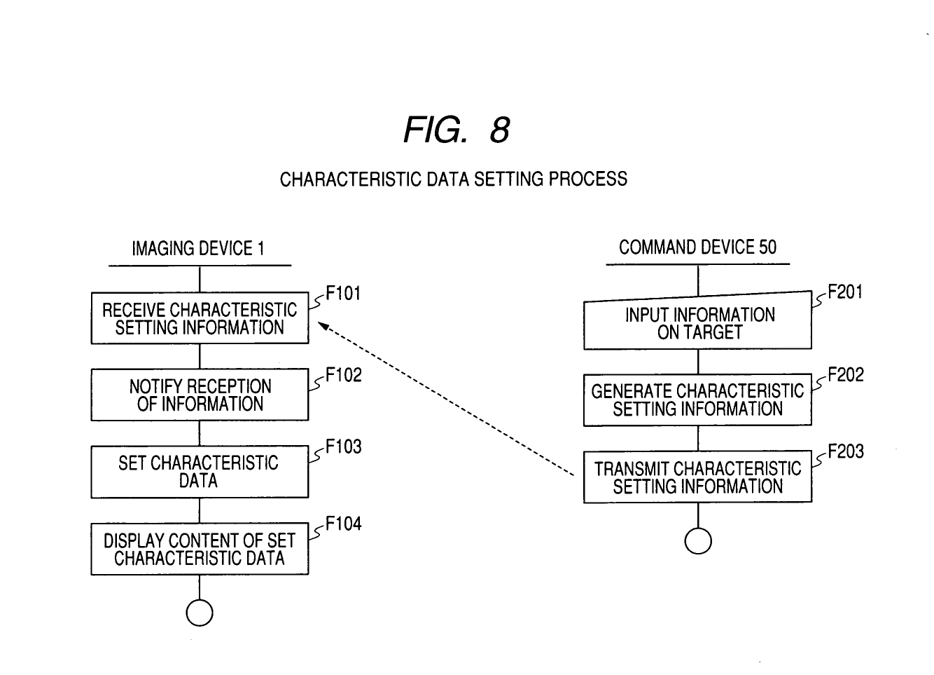

A characteristic data setting function 61 is a function of setting characteristic data on the basis of characteristic setting information transmitted from the command device 50. For example, the characteristic data setting function 61 is a function of performing a process shown in FIG. 8.

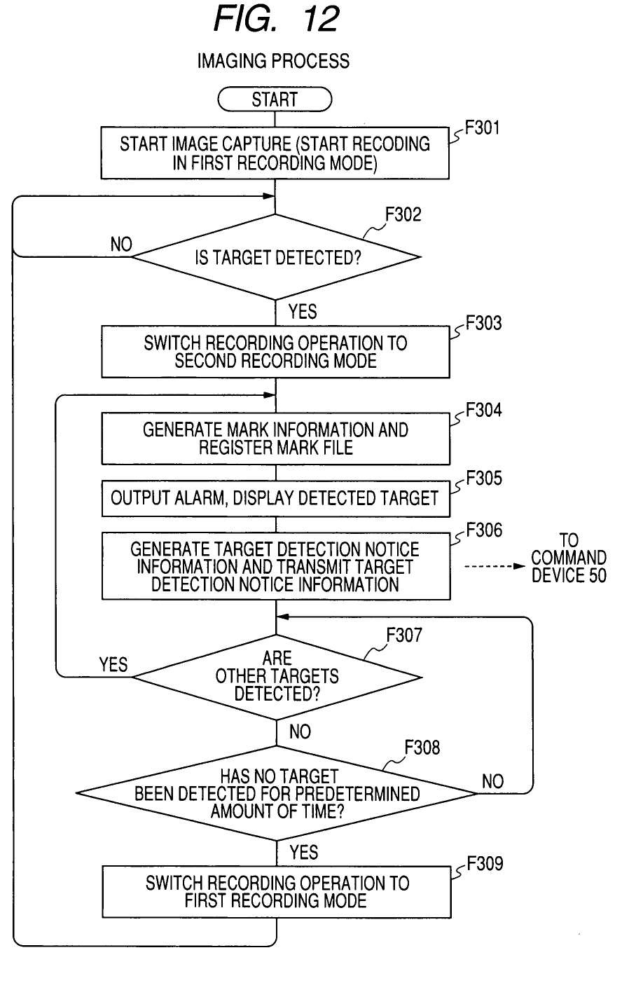

An imaging process control function 62 is a function of controlling various operations during image capturing, such as an image capturing operation, a recording operation, a mark information processing operation, a target image data detecting operation, a target detection notice information generating operation, and a target detection notice information transmitting operation. For example, the imaging process control function 62 is a function of performing a process shown in FIG. 12.

A command information processing function 63 is a function of notifying the user of the content of command information received from the command device 50. For example, the command information processing function 63 is a function of performing a process shown in FIG. 18.

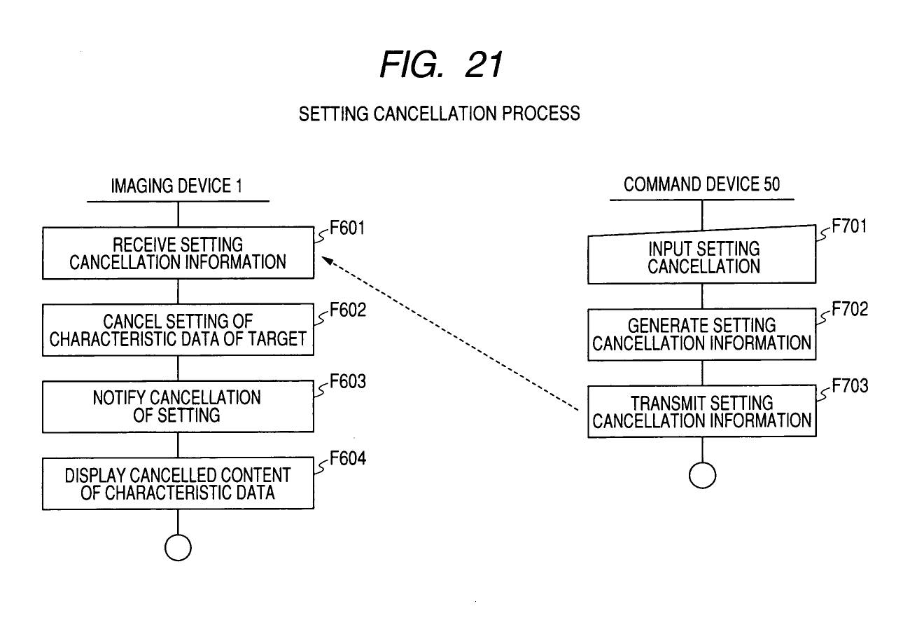

A setting cancellation processing function 64 is a function of canceling the setting of specific characteristic data on the basis of setting cancellation information transmitted from the command device 50. For example, the setting cancellation processing function 64 is a function of performing a process shown in FIG. 21.

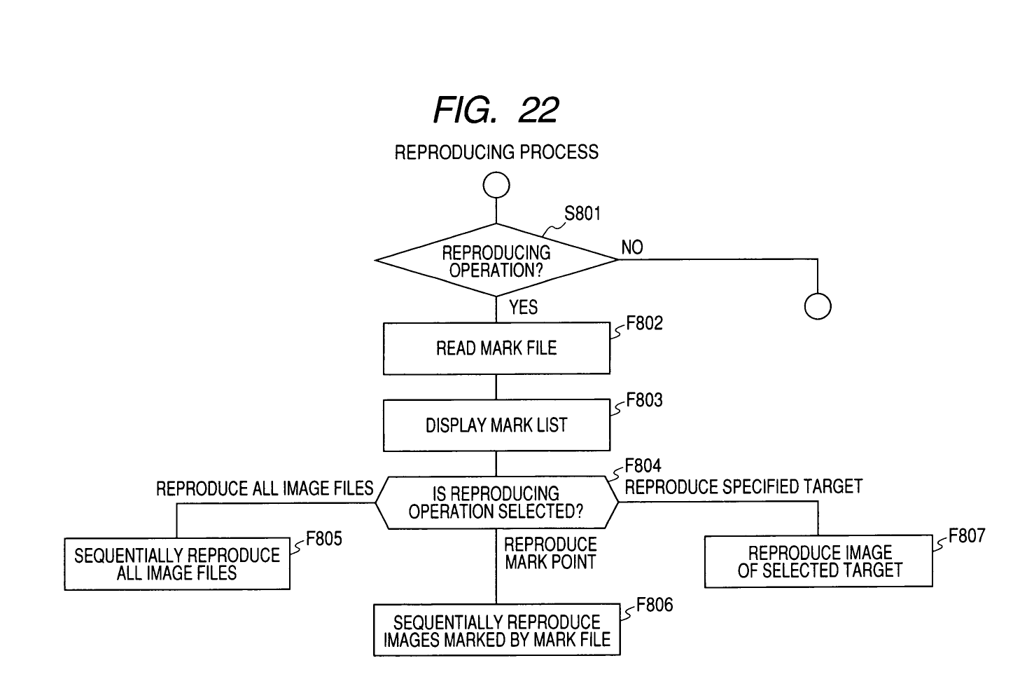

A mark image reproducing function 65 is a function of using a mark file to reproduce marked target image data. For example, the mark image reproducing function 65 is a function of performing a process shown in FIG. 22.

The imaging device 1 of this embodiment has the above-mentioned structure, but various modifications of the imaging device can be made as follows.

All the blocks shown in FIG. 5, serving as constituent elements, are not necessarily needed, and the imaging device 1 may have additional constituent elements.

As shown in FIG. 5, the image analyzing unit 32, the sound analyzing unit 38, the transmission data generating unit 42, the received data processing unit 43, and the display data generating unit 44 may be separately configured as a circuit unit from the controller 40 (CPU) in a hardware manner. The operations of the above-mentioned units may be performed by a so-called arithmetic process. Alternatively, a software program may allow the controller 40 to perform the functions of the above-mentioned units.

The outward appearance of the camera unit 2 and the control unit 3 shown in FIG. 2 is just an illustrative example, but operators for an actual user interface, devices for display, and the shape of a case are not limited thereto. In addition, when the structure of components is changed, the shapes of the components may vary.

In this embodiment, the camera unit 2 and the control unit 3 are connected to each other through the cable 4, but the invention is not limited thereto. For example, radio waves or infrared rays may be used to wirelessly transmit video signals or audio signals of captured images between the camera unit 2 and the control unit 3.

Further, the camera unit 2 may not be separated from the control unit 3 as shown in FIG. 2, and the camera unit 2 and the control unit 3 may be integrated into one unit.

Furthermore, the display unit 11 may be separately provided, considering the visibility of the display unit by a user, such as a policeman. For example, a wristwatch-type display unit may be provided. In addition, a wristwatch-type control unit 3 may be provided.

In this embodiment, the front camera portion 21a and the rear camera portion 21b are provided, but the invention is not limited thereto. For example, at least one of the front camera portion 21a and the rear camera portion 21b may be provided.

Alternatively, three or more camera portions may be provided.

When two or three or more camera portions are provided, the microphones may be provided to correspond to the number of camera portions. Alternatively, a common microphone to some or all of the camera portions may be provided. Of course, one or more microphones may be provided.

Further, when one or more camera portions are provided, some or all of the camera portions may have a fan/tilt structure so as to move in all direction to capture images.

The fan/tilt operation of the camera portion may be performed by the user, or it may be automatically controlled by the controller 40.

In this embodiment, the memory card 5 is given as an example of the recording medium, but the invention is not limited thereto. For example, an HDD (hard disc drive) may be provided in the recording/reproduction processing unit 33, or an optical disk or a magneto-optical disk may be used as the recording medium. Of course, a magnetic tape medium may be used as the recoding medium.

3. Structure of Command Device

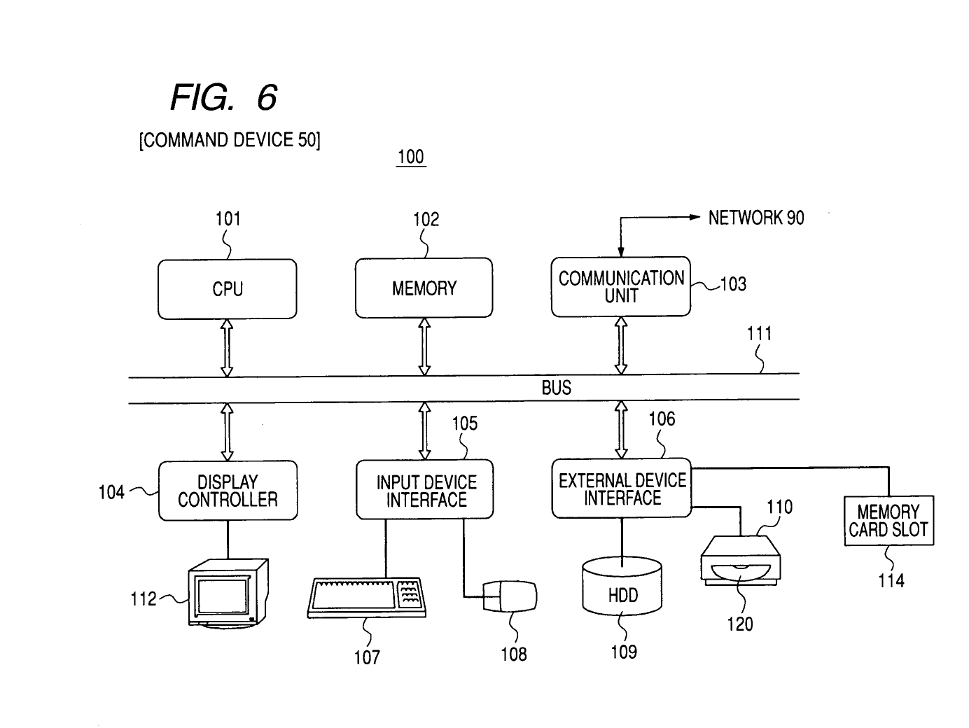

The structure of the command device 50 will be described with reference to FIG. 6. The command device 50 can be realized by a computer system, such as a personal computer or a workstation, in a hardware manner. The structure of a computer system 100 that can be used as the command device 50 will be described with reference to FIG. 6, and a configuration for allowing the computer system 100 to function as the command device 50 will be described with reference to FIG. 7A.

FIG. 6 is a diagram schematically illustrating an example of the hardware structure of the computer system 100. As shown in FIG. 6, the computer system 100 includes a CPU 101, a memory 102, a communication unit (network interface) 103, a display controller 104, an input device interface 105, an external device interface 106, a keyboard 107, a mouse 108, an HDD (hard disc drive) 109, a media drive 110, a bus 111, a display device 112, and a memory card slot 114.

The CPU 101, which is the main controller of the computer system 100, performs various applications under the control of an operating system (OS). When the computer system 100 is used as the command device 50, the CPU 101 executes applications for realizing a characteristic setting information generating function 71, a target detection notice correspondence function 72, a command processing function 73, a setting cancellation instructing function 74, and a mark image reproducing function 75, which will be described with reference to FIG. 7B.

As shown in FIG. 6, the CPU 101 is connected to other components (which will be described later) through the bus 111. Unique memory addresses or I/O addresses are allocated to the above-mentioned components connected to the bus 111, and the addresses enable the CPU 101 access the components. A PCI (peripheral component interconnect) bus is used as an example of the bus 111.

The memory 102 is a storage device used to store the programs executed by the CPU 101 or to temporarily store work data being executed. As shown in FIG. 6, the memory 102 includes both a volatile memory and a non-volatile memory. For example, the memory 102 includes a volatile memory, such as a ROM for storing programs and a non-volatile memory, such as an EEP-ROM or a RAM for temporarily storing an arithmetic work area or various data.

The communication unit 103 can connect the computer system 100 to the network 90 through the Internet, a local area network (LAN), or a dedicated line according to a predetermined communication protocol, such as Ethernet (registered trademark) such that the computer system 100 can communicate with the imaging device 1. In general, the communication unit 103, serving as a network interface, is provided in the form of a LAN adapter card and is inserted into a PCI slot on a mother board (not shown). However, the computer system 100 may be connected to an external network through a modem (not shown), not the network interface.

The display controller 104 is a dedicated controller for actually processing a drawing command issued by the CPU 101 and supports a bitmap drawing function corresponding to, for example, SVGA (super video graphic array) or XGA (extended graphic array). The drawing data processed by the display controller 104 is temporarily written to, for example, a frame buffer (not shown) and is then output to the display device 112. For example, a CRT (cathode ray tube) display, a liquid crystal display (LCD) is used as the display device 112.

The input device interface 105 is a device for connecting user input devices, such as the keyboard 107 and the mouse 108, to the computer system 100. That is, an operator for operating the command device 50 in the police station uses the keyboard 107 and the mouse 108 to input operational commands into the computer system 100.

The external device interface 106 is a device for connecting external devices, such as the hard disc drive (HDD) 109, the media drive 110, and the memory card slot 114, to the computer system 100. For example, the external device interface 106 is based on an interface standard such as IDE (integrated drive electronics) or SCSI (small computer system interface).

The HDD 109 is an external device having a magnetic disk, serving as a recording medium, mounted therein, and has storage capacity and data transmitting speed higher than other external storage devices. Setting up an executable software program on the HDD 109 is called installing a program in the system. In general, program codes of an operating system, application programs, and device drivers to be executed by the CPU 101 are stored in the HDD 109 in a non-volatile manner.

For example, application programs for various functions executed by the CPU 101 are stored in the HDD 109. In addition, a face database 57 and a map database 58, which will be described later, are constructed in the HDD 109.

The media drive 110 is a device for access a data recording surface of a portable medium 120, such as a compact disc (CD), a magneto-optical disc (MO), or a digital versatile disc (DVD), inserted therein. The portable medium 120 is mainly used to back up a software program or a data file as computer readable data or move (including selling and distribution) the computer readable data between systems.

For example, it is possible to use the portable medium 120 to distribute applications for realizing the functions described with reference to FIG. 7B.

The memory card slot 114 is a memory card recording/reproduction unit that performs recording or reproduction on the memory card 5 used in the imaging device 1, as described above.

FIG. 7B shows the functions of the command device 50 constructed by the computer system 100.

FIGS. 7A and 7B show processing functions executed by the CPU 101.

The CPU 101 executes the characteristic setting information generating function 71, the target detection notice correspondence function 72, the command processing function 73, the setting cancellation instructing function 74, and the mark image reproducing function 75. For example, application programs for realizing these functions are installed in the HDD 109, and the CPU 101 executes the application programs to process these functions.

The characteristic setting information generating function 71 is a function of generating characteristic setting information for allowing the imaging device 1 to set characteristic data and of transmitting the generated characteristic setting information from the communication unit 103 to the imaging device 1. For example, the characteristic setting information generating function 71 is a function of performing a process shown in FIG. 8.

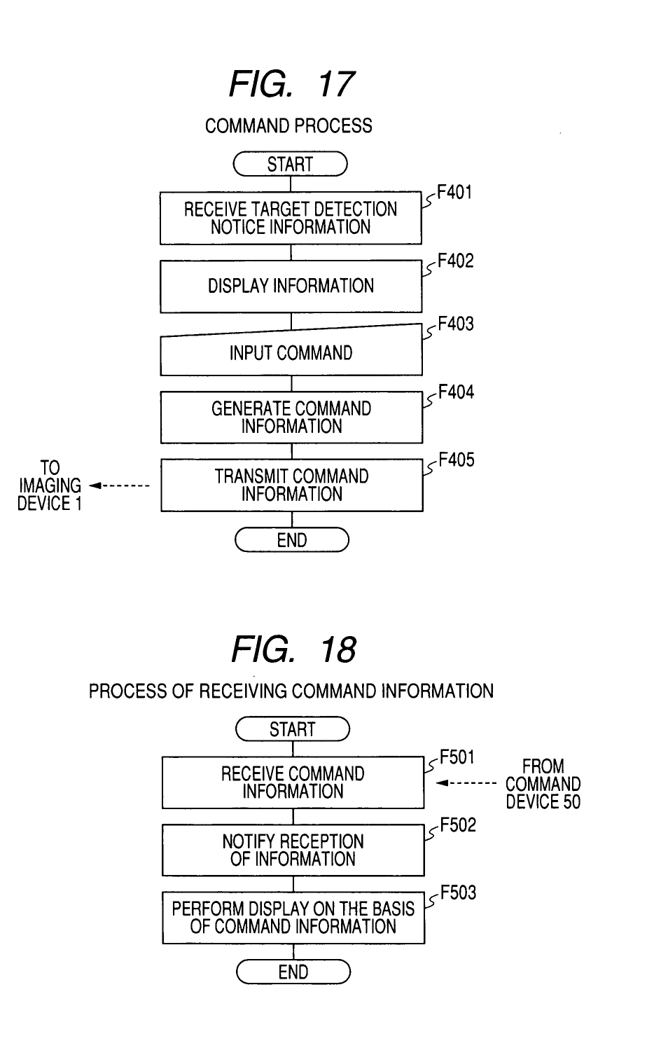

When the target detection notice information is transmitted from the imaging device 1, the target detection notice correspondence function 72 receives the target detection notice information and displays the content thereof. For example, the target detection notice correspondence function 72 is a function of performing processes shown in steps F401 and F402 of FIG. 17.

The command processing function 73 generates command information in order to issue a command to a policeman wearing the imaging device 1 and transmits the command information from the communication unit 103 to the imaging device 1. For example, the command processing function 73 is a function of performing processes shown in steps F403 to F405 of FIG. 17.

The setting cancellation instructing function 74 generates setting cancellation information in order to cancel the characteristic data set in the imaging device 1 and transmits the setting cancellation information from the communication unit 103 to the imaging device 1. For example, the setting cancellation instructing function 74 is a function of performing a process shown in FIG. 21.

The mark image reproducing function 75 is a function of using a mark file to reproduce marked target image data. For example, the mark image reproducing function 75 is a function of performing a process shown in FIG. 22. For example, when the memory card 5 having an image file and a mark file stored therein is inserted into the memory card slot 114 in the imaging device 1, the mark image reproducing function 75 uses the mark file to perform reproduction.

4. Process of Setting Characteristic Data

Operations performed by the imaging device 1 and the command device 50 having the above-mentioned structure will be described below. First, the operation of the imaging device 1 setting characteristic data according to commands from the command device 50 will be described.

For the purpose of simplicity of explanation, it is assumed that characteristic data is the color of an article or the color of the clothes of a person in the following operations. However, the characteristic data is not limited to the color. For example, the appearance, behavior, and voice of a person, or the shape, movement, and sound of an article that can be detected from image data, other than the color, may be set as the characteristic data. The system sets characteristic data as the color in the following operations.

FIG. 8 is a diagram illustrating processes performed by the controller 40 of the imaging device 1 and processes performed by the CPU 101 (characteristic setting information generating function 71) of the command device 50.

In step F201 performed in the command device 50, information on a target (an object to be searched) is input. An operator operating the command device 50 uses input devices, such as the keyboard 107 and the mouse 108, to input characteristic data indicating the target. For example, the operator inputs information indicating ‘a person wearing green clothes’ or ‘a black wagon’.

The CPU 101 (characteristic setting information generating function 71) generates characteristic setting information in response to the input of the information in step F202.

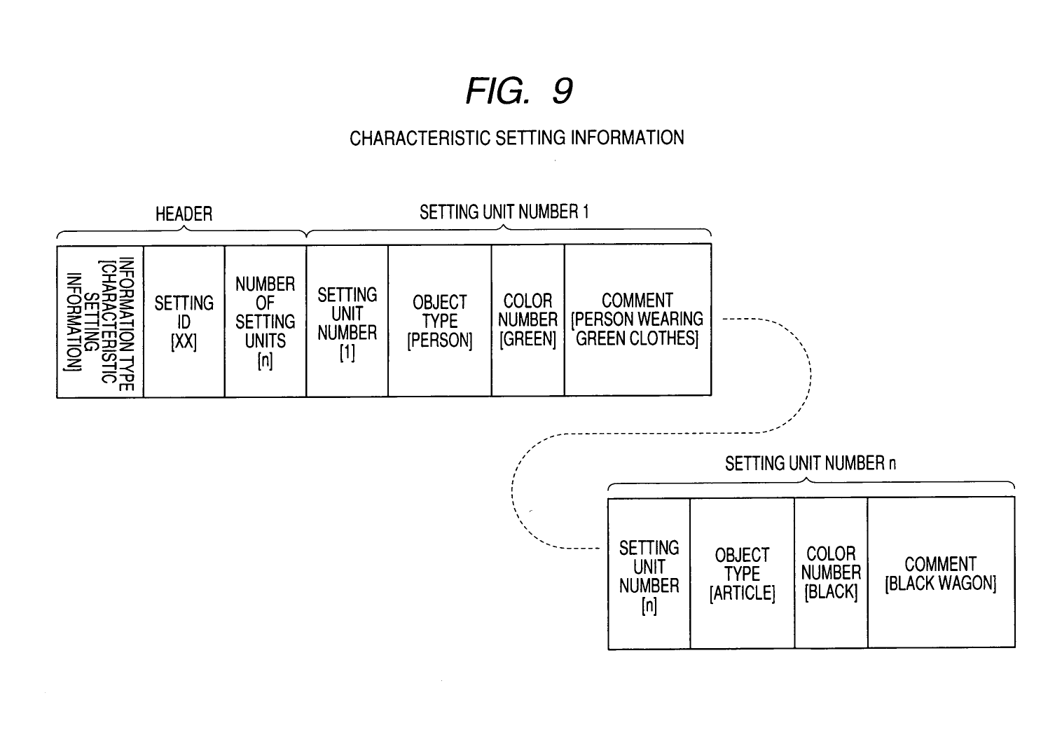

FIG. 9 shows an example of the structure of information packet serving as characteristic setting information to be generated.

First, a header of the characteristic setting information includes an information type, setting ID, and a setting unit number.

‘Characteristic setting information’ is indicated as the information type.

Unique ID given to the characteristic setting information is indicated as the setting ID. A unique value obtained by combining an identification number uniquely assigned to the command device 50 or a policeman with the date and hour (second, minute, hour, day, month, and year) when the characteristic setting information is generated is indicated as the setting ID.

The number of setting units included in the characteristic setting information is indicated as the setting unit number.

The setting unit is one information item that is set as characteristic data in the imaging device 1, and one or more setting units are included in the characteristic setting information (setting unit numbers 1 to n).

A setting unit number, an object type, a color number, and a comment are included in one setting unit.

The setting unit numbers are for identifying setting units included in one characteristic setting information item. For example, values corresponding to numbers ‘1’ to ‘n’ are described as the setting unit numbers.

The object type is information indicating the type of, for example, a person or an article.

A code value indicating the color is described as the color number.

For example, text data provided to a policeman in the imaging device 1 is included in the comment.

For example, the setting unit number 1 indicates that ‘a person wearing green clothes’ is a target, and the setting unit number n indicates that ‘a black wagon’ is a target.

In this embodiment, as described above, when the color of an article or the color of the clothes of a person is set as the characteristic data, the characteristic setting information has the above-mentioned structure, but the invention is not limited thereto. For example, even when the appearance, behavior, and sound of a person other than the color are set as the characteristic data, the characteristic setting information may have a data structure corresponding thereto.

For example, when the characteristic setting information shown in FIG. 9 is generated, the characteristic setting information generating function 71 transmits the characteristic setting information in step F203. That is, the CPU 101 sends the generated characteristic setting information to the communication unit 103 to transmit the characteristic setting information to the imaging device 1.

In the controller 40 of the imaging device 1, the characteristic data setting processing function 61 performs processes in steps F101 to F104.

In step F101, the characteristic setting information is received from the command device 50. When information is received by the communication unit 34 and the received data processing unit 43, the received information is supplied to the controller 40. The controller 40 checks whether the information received in step F101 is characteristic setting information on the basis of the type of received information, and processes the received information on the basis of the characteristic data setting processing function 61.

In this case, the process proceeds from steps F101 to F102 to notify the user (policeman) that information is received. An electronic sound or a message sound indicating the reception of information is output from the sound output unit 14, or the vibrator in the non-sound notifying unit 35 is operated to notify the reception of information.

Next, the controller 40 performs a characteristic setting process in step F103. The characteristic setting process sets (registers) the characteristic data indicated in the setting unit of the characteristic setting information as characteristic data of target image data to be detected by the imaging device 1.

For example, when characteristic setting information including the content of the setting unit numbers 1 and n shown in FIG. 9 is received, ‘a person wearing green clothes’ or ‘a black wagon’ is set as characteristic data. For example, the characteristic data is registered in a characteristic data setting area in a non-volatile memory of the memory unit 41.

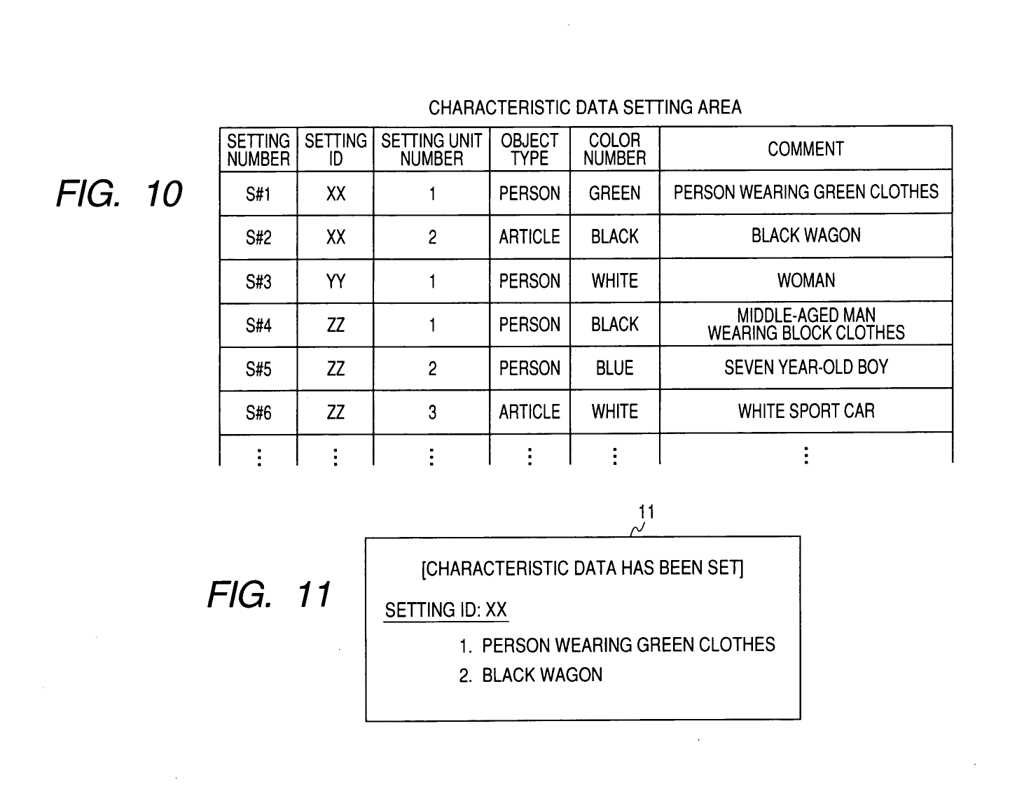

FIG. 10 shows an example of characteristic data registered in the characteristic data setting area of the memory unit 41.

The characteristic data having setting numbers S#1, S#2, . . . , are registered.

Setting ID, a setting unit number, an object type, a color number, and a comment are registered in the characteristic data setting area.

Characteristic setting information and a setting unit are indicated by the setting ID and the setting unit number. The content indicated in the setting unit is registered by the object type, the color number, and the comment.

For example, when the characteristic setting information shown in FIG. 9 is received, as shown in the setting number S#1 of FIG. 10, information items of the setting unit number 1, such as a setting ID ‘XX’, a setting unit number ‘1’, an object type ‘person’, a color number ‘green’, a comment indicating ‘a person wearing green clothes’, are set as characteristic data.

In the case of the setting unit number n (n=2), as shown in the setting number S#2 of FIG. 10, information items of the setting unit number 2, such as a setting ID ‘XX’, a setting unit number ‘2’, an object type ‘article’, a color number ‘black’, and a comment indicating ‘a black wagon’, are set as one characteristic data.

As shown in FIG. 10, the characteristic data registered in the characteristic data setting area is transmitted to the image analyzing unit 32, and the image analyzing unit 32 searches the characteristic data when an image is captured. For example, when the characteristic data of the setting number S#1 is registered, ‘a person wearing green clothes’ is set as a target of when an image is captured.

When characteristic data as a sound is set, the characteristic data is supplied to the sound analyzing unit 38, and the sound analyzing unit 38 searches the characteristic data when an image is captured.

Next, the controller 40 controls the display unit 11 to display the content of characteristic data newly set in step F104. That is, the controller 40 supplies the content of the characteristic data, particularly, information of the comment included in each setting unit to the display data generating unit 44 and controls the display unit 11 to display the content of the characteristic data.

In this case, for example, display is performed as shown in FIG. 11. The policeman having the imaging device 1 checks instructions transmitted from the police station (command device 50) through the display unit 11 when the reception of information is notified in step F102. In this case, the policeman can know that new characteristic data of an object to be searched is set through the display shown in FIG. 11 by the process in step F104.

The characteristic data is information indicating a target whose image will be captured by the imaging device 1. When the policeman having the imaging device 1 recognizes set characteristic data, the characteristic data is useful for the actual patrol, and it is effective to perform the display shown in FIG. 11. For example, when the policeman can check that characteristic data indicating ‘a person wearing green clothes’ is set through the displayed content, the policeman can pay attention to ‘a person wearing green clothes’ on patrol.

When the command device 50 includes more detailed content or command in the comment of the characteristic setting information, the policeman can receive detailed information and command from the command device 50.

5. Image Capturing Process of Imaging Device

Next, an image capturing process of the imaging device 1 will be described with reference to FIG. 12. The policeman starts operating the imaging device 1 to capture images on patrol. Then, the imaging device 1 automatically operates on the basis of a process shown in FIG. 12.

FIG. 12 is a flowchart illustrating a control process of the controller 40 by the imaging process control function 62.

When the policeman operates the imaging device 1 to capture images, the controller 40 performs image capture start control in step F301. That is, the controller 40 controls the camera unit 2 and the video/audio signal processing units 31a and 31b to start an image capturing operation. In addition, the controller 40 controls the recording/reproduction processing unit 33 to start recording captured image data. Further, the controller 40 controls the image analyzing unit 32 and the sound analyzing unit 38 to start an analyzing process.

The recording/reproduction processing unit 33 performs a compression process or an encoding process corresponding to a recording format on the image data supplied from the video/audio signal processing units 31a and 31b and records the image data on the memory card 5. The controller 40 controls the recording/reproduction processing unit 33 to start recording the image data in the first recording mode.

The recording/reproduction processing unit 33 can record moving pictures or automatically records still pictures at predetermined time intervals. In this embodiment, the recording/reproduction processing unit 33 records still picture data at a predetermined time interval (for example, at a time interval of about one second) as one image file.

A first recording mode and a second recording mode have different compression ratios. For example, image data is recorded at a high compression ratio in the first recording mode, and image data is recorded at a low compression ratio in the second recording mode. That is, an image file having a small data size and a relatively low image quality is recorded in the first recording mode, and an image file having a large data size and a relatively high image quality is recorded in the second recording mode.

Various recording operations may be performed in the first recording mode and the second recording mode, which will be described later as modifications of the invention.

When image capture, image recording in the first recording mode, and an analysis process start in step F301, image data that has been captured by the camera unit 2 and then processed by the video/audio signal processing units 31a and 31b is recorded onto the recording/reproduction processing unit 33 at a predetermined time interval.

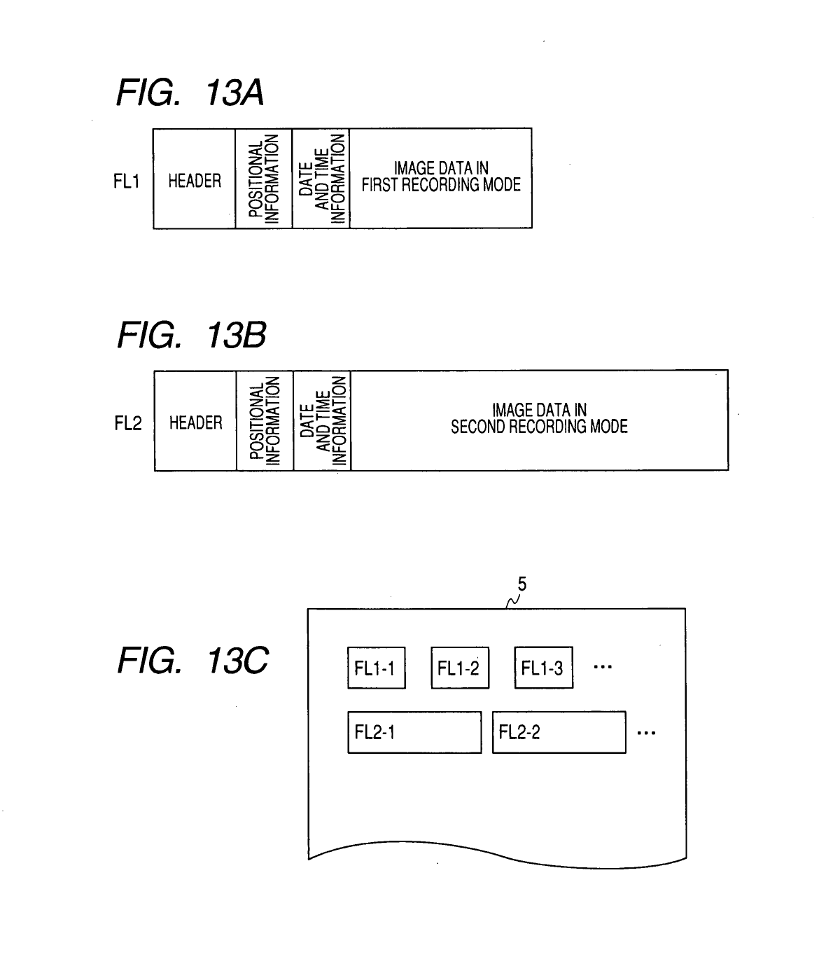

The recording/reproduction processing unit 33 performs a compression process, an encoding process for recording, and a filing process the image data supplied at a predetermined time interval to generate an image file FL1 in the first recording mode shown in FIG. 13A, and records the image file FL1 onto the memory card 5.

The image file FL1 includes, for example, a header, positional information, date and time information, and image data in the first recording mode.

A file name, a file attribute, a compression method, a compression ratio, an image data size, and an image format are described in the header.

Information of the latitude and longitude of an object that is detected by the position detecting unit 36 as current position information at the time of image capture is supplied from the controller 40 to the recording/reproduction processing unit 33 as positional information and is then recorded thereon.

The date and time information is the current date and time obtained by a time measuring process, which is an internal process performed by the controller 40, or a time code corresponding to each frame of image data.

When recording is performed in the first recording mode, the image files FL1 (FL1-1, FL1-2, FL1-3, . . . ) are sequentially recorded on the memory card 5, as shown in FIG. 13C.

When image capture and recording are performed in this way, the image data obtained by the video/audio signal processing unit 31 is also supplied to the image analyzing unit 32 and the image analyzing unit 32 analyzes image data of each frame. In addition, the audio data obtained by the video/audio signal processing unit 31 is supplied to the sound analyzing unit 38, and the sound analyzing unit 38 analyzes the audio data.

When an image corresponding to one characteristic that is set as characteristic data is detected by the image analyzing unit 32, the image analyzing unit 32 notifies the controller 40 that a target is detected (or when the sound analyzing unit 38 detects audio data corresponding to characteristic data, the sound analyzing unit 38 notifies the controller 40 that a target is detected).

When the controller 40 receives a notice of the detection of a target from the image analyzing unit 32 (or the sound analyzing unit 38), the process proceeds from step F302 to step F303.

In step F303, the controller 40 instructs the recording/reproduction processing unit 33 to switch the recording operation to the second recording mode.

In this way, image data obtained by capturing the image of a person wearing green clothes, which is image data captured at the time when the recording operation is switched to the second recording mode, that is, target image data obtained by the detection of a target, and the subsequent image data are recorded in the second recording mode as a high-quality image file onto the recording/reproduction processing unit 33.

When the recording operation is switched to the second recording mode, for example, a compression ratio is changed, as described above. As shown in FIG. 13B, an image file FL2 recorded in the second recording mode includes, for example, a header, positional information, date and time information, and image data in the second recording mode. The header, the positional information, and the date and time information are the same as those of the image file FL1 recorded in the first recording mode. The change in the compression ratio causes the quality of the image data in the image file FL2 to be higher than the quality of the image data in the image file FL1.

When recording is performed in the second recording mode after step S303, image files FL2 (FL2-1, FL2-1, . . . ) are sequentially recorded onto the memory card 5, as shown in FIG. 13C.

In step F304, the controller 40 instructs the recording/reproduction processing unit 33 to perform marking. In this case, the recording/reproduction processing unit 33 generates mark information on target image information to be recorded and registers the mark information onto the mark file.

That is, the recording/reproduction processing unit 33 performing marking on target image data to be recorded in the second recording mode. The recording/reproduction processing unit 33 generates mark information and registers (or updates) a mark file including the current mark information to the memory card 5.

The mark information includes an address for recording target image data or corresponding characteristic data.

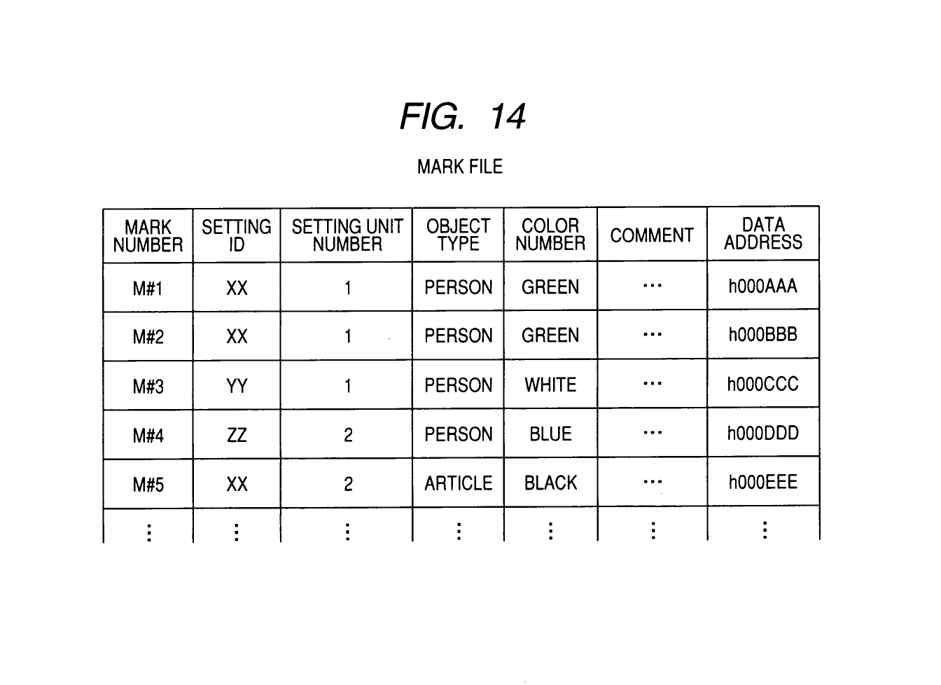

FIG. 14 shows an example of a mark file having mark information registered thereon.

Mark information items are registered as mark numbers M#1, M#2, . . . . Each of the mark information items includes the content of characteristic data corresponding to target image data (for example, a setting ID, a setting unit number, an object type, a color number, and a comment), and an address of a recording area in the memory card 5 having the target image data recorded thereon (or reproduction point information).

Mark information registered as the mark number M#1 in FIG. 14 is mark information registered when a person wearing green clothes is detected from captured image data by the image analyzing unit 32.

When still pictures are sequentially recorded, marking (mark information recording) may be performed on target image data including an image corresponding to characteristic data at the beginning. For example, when a person wearing green clothes is detected from captured image data and the image data is recorded in the second recording mode as the image file FL2-1, the marking process is performed on the image file FL2-1. However, marking information may not be registered on image files that are recorded as the subsequent image files FL2-2, FL2-3, . . . . In some cases, the recorded image files may be reproduced in the order in which they are recorded. That is, it is premised that each image file deals like each frame image of an intermittent moving picture. This is similarly applied to the recording of moving pictures.

When still pictures are recorded, as a modification, the marking process may be performed on all target image data, for example, all the image files FL2 from which ‘a person wearing green clothes’ is detected.

Then, in step F305, the controller 40 performs alarm output to notify the policeman, who is the user, that a target is detected. For example, the controller 40 controls the sound output unit 14 to output an electronic sound or a message sound indicating the detection of a target. Alternatively, the controller 40 controls the non-sound notifying unit 35 to generate vibration.

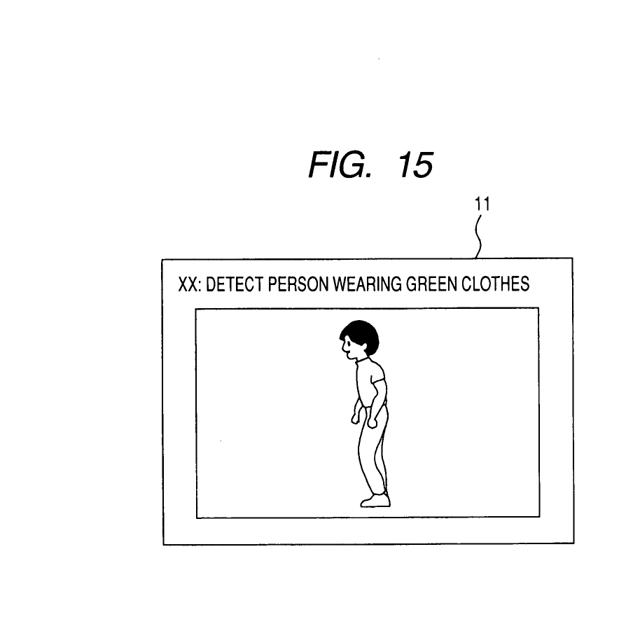

Further, in order to display an image indicating the detection of a target, the controller 40 supplies target image data or the content of corresponding characteristic data to the display data generating unit 44 and controls the display unit 11 to display the target image data as an image, as shown in FIG. 15. Then, when the alarm sounds, the policeman can view the image displayed on the display unit 11 and check a person detected as a target.

In step F306, the controller 40 instructs the transmission data generating unit 42 to generate target detection notice information and controls the communication unit 34 to transmit the target detection notice information generated by the transmission data generating unit 42 to the command device 50.

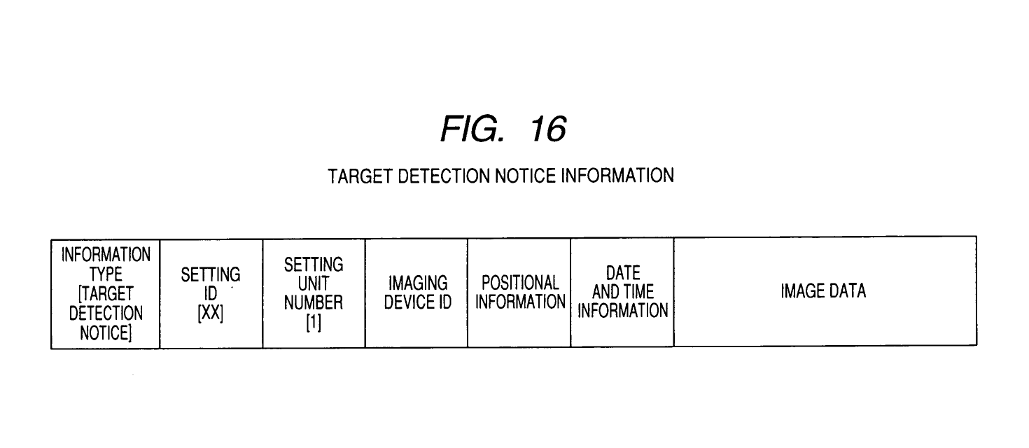

The transmission data generating unit 42 generates target detection notice information shown in FIG. 16 according to the instruction from the controller 40.

As shown in FIG. 16, the target detection notice information includes an information type, a setting ID, a setting unit number, an imaging device ID, positional information, date and time information, and image data.

‘Target detection notice information’ is indicated as the information type.

One characteristic data corresponding to a target is indicated by the setting ID and the setting unit number.

An identification number that is uniquely assigned to the imaging device 1 is described as the imaging device ID, and the imaging device 1, which is a source, is indicated by the imaging device ID.

The positional information indicates a position where target image data is captured, and the date and time information indicates an image capture time.

The target detection notice information includes target image data as the image data.

The positional information, the date and time information, and the target image data may be read from the image file FL2 (that is, the image file subjected to the marking process) recorded by the recording/reproduction processing unit 33 when a target is detected, and the positional information, the date and time information, and the target image data included in the image file FL2 may be supplied to the transmission data generating unit 42 so as to be included in the target detection notice information.

The image data may be one (one frame) image as target image data. For example, the target detection notice information may include a series of image data continued from the target image data that is detected at the beginning. When the recording/reproduction processing unit 33 records moving pictures, moving picture data may be arranged at predetermined time intervals, with a frame detected as target image data at the head.

When the target detection notice information is generated by the transmission data generating unit 42, the controller 40 controls the communication unit 34 to transmit the target detection notice information to the command device 50. That is, the target detection notice information having the content shown in FIG. 16 is transmitted to the command device 50.

In step F307, the controller 40 determines whether other targets, that is, image data or audio data corresponding to other set characteristic data are detected by the image analyzing unit 32 or the sound analyzing unit 38.

In step F308, the controller 40 checks whether there is no target detection notice from the image analyzing unit 32 or the sound analyzing unit 38 during a predetermined amount of time or more.

When there is a target detection notice corresponding to another characteristic data from the image analyzing unit 32 or the sound analyzing unit 38, the control unit 40 returns to step F304 and performs the marking process (F304), the alarm and target detection display process (F305), and the target detection notice information transmitting process (F306) as the processes corresponding to the detection of target image data corresponding to another characteristic data.

When the detection of a target by the image analyzing unit 32 or the sound analyzing unit 38 is not performed during a predetermined amount of time or more (for example, 3 minutes to 5 minutes), the controller 40 performs step F309 to instruct the recording/reproduction processing unit 33 to switch the recording operation to the first recording mode and returns to step F302. The recording/reproduction processing unit 33 switches the recording operation to the first recording mode according to the instruction from the controller 40 and continues to record image data.

When the processes shown in FIG. 12 are executed in the imaging device 1, a captured image or a sound corresponding to characteristic data is detected in the imaging device 1, the recording position of the image on the memory card 5 is marked, and target detection notice information is transmitted to the command device 50.

6. Command Process of Command Device

The process of the command device 50 when target detection notice information is transmitted from the imaging device 1 and a process of transmitting command information from the command device 50 to the imaging device 1 will be described with reference to FIG. 17.

The CPU 101 performs steps F401 and F402 shown in FIG. 17 on the basis of the target detection notice correspondence function 72 in the command device 50. The CPU 101 performs steps F403 to F405 on the basis of the command processing function 73.

In step F401, the communication unit 103 receives target detection notice information, and the CPU 101 acquires the target detection notice information.

The CPU 101 checks in step F401 that the received information is the target detection notice information according to the information type. Then, when the CPU 101 acquires the target detection notice information, the CPU 101 controls the display device 112 to display the content of the target detection notice information in step F402.

That is, the CPU 101 controls the display device 112 to display an image, positional information, and date and time information included in the target detection notice information. In addition, the CPU 101 controls the display device 112 to display the content of characteristic data corresponding to a target.

The police staff operating the command device 50 views the image included in the target detection notice information and checks whether the displayed person or article is a person or an article to be searched.

Then, the police staff issues a command to the policeman having the imaging device 1 capturing the image.

The police staff inputs a command in step F403.

When text data is input as a command, the CPU 101 (command processing function 73) generates command information in step F404.

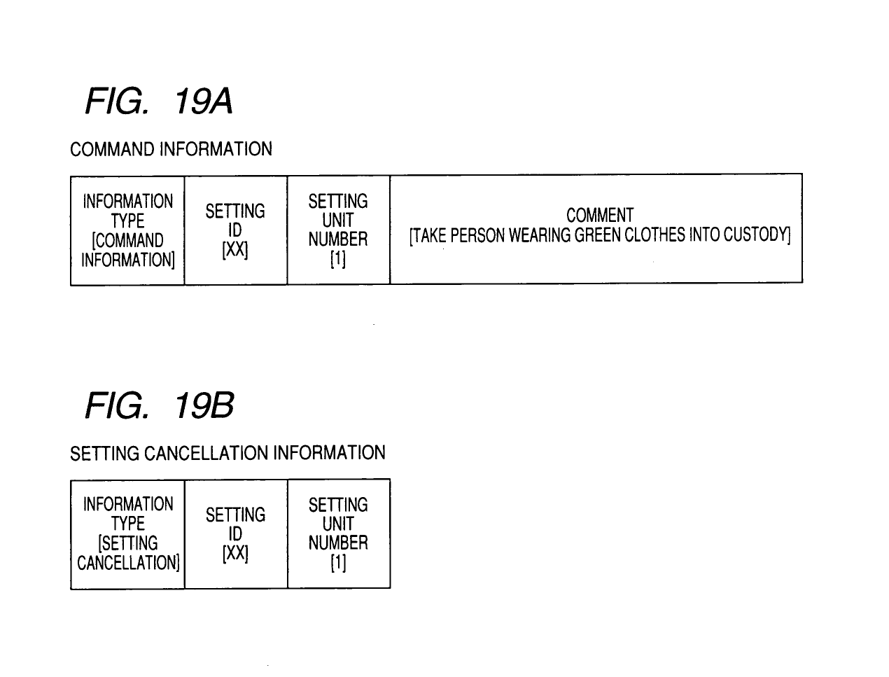

For example, the command information is configured as shown in FIG. 19A, and includes an information type, a setting ID, a setting unit number, and a comment.

‘Command information’ is indicated as the information type.

Characteristic data corresponding to the current command is indicated by the setting ID and the setting unit number.

For example, text data, which is the content of the command input in step F403, is included in the command information as the comment.

When the command information is generated in step F404, the CPU 101 controls the communication unit 103 to transmit the command information to the imaging device 1 in step F405.

When the target detection notice information is received from the imaging device 1, the command device 50 performs the processes shown in FIG. 17. In the process of display information in step F402, since the image captured by the imaging device 1, the date of image capture, and the place where the image is captured are displayed, the police staff can issue a command corresponding to a situation determined from the captured image, the date of image capture, and the place where the image is captured.

For example, when it is determined that a person on the image displayed in step F402 is a fugitive criminal, the police staff inputs a command to take a person wearing green clothes into custody in step F403. Then, command information including the command is transmitted to the imaging device 1.

7. Process of Imaging Device when Receiving Command Information

FIG. 18 is a flowchart illustrating the process of the imaging device 1 when receiving the command information from the command device 50. The process is performed by the controller 40 on the basis of the command information processing function 63.

In step F501, the communication unit 34 receives the command information from the command device 50.

When acquiring the received information by the processes of the communication unit 34 and the received data processing unit 43, the controller 40 checks that the received information is command information according to the information type, and the process of the controller 40 proceeds from step F501 to F502 on the basis of the command information processing function 63.

In step F502, the controller 40 notifies the user (policeman) that the command information is received. That is, the controller 40 controls the sound output unit 14 to output an electronic sound or a message sound indicating the reception of the command information, or controls the non-sound notifying unit 35 to operate the vibrator to notify the user that the command information is received.

Then, in step F502, the controller 40 transmits information to be shown to the display data generating unit 44 and controls the display data generating unit 44 to generate display data on the basis of the content of the received command information.

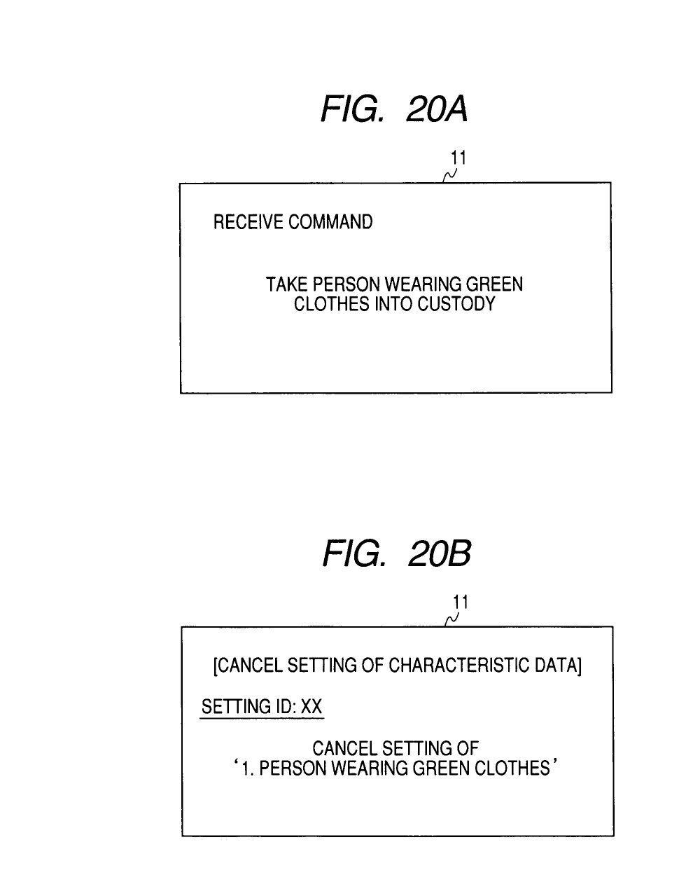

For example, the controller 40 controls the display data generating unit 44 to generate display data indicating the content of the comment included in the command information. The display unit 11 performs display on the basis of the display data. For example, as shown in FIG. 20A, the display unit 11 displays the comment included in the command information, that is, the content of the command issued from the police station, which is police headquarters.

When receiving the notice of the reception of command information in step F502, the policeman having the imaging device 1 checks the content of the command received from the police station (command device 50) that is displayed on the display unit 11. In this case, when text shown in FIG. 20A is displayed in step F503, the policeman can know the content of the command issued by the police headquarters, and can take an action corresponding to the command, such as an action to arrest a criminal or an action to take a mission person into protective custody.

8. Process of Canceling Setting of Characteristic Data

As described above, the setting of the characteristic data in the imaging device 1 is performed on the basis of the characteristic setting information transmitted from the command device 50. The characteristic data indicates the characteristic of a person to be searched, such as a fugitive criminal or a mission person, and is unavailable after the person to be searched is arrested or taken into protective custody. Therefore, the command device 50 transmits setting cancellation information to the imaging device 1 to cancel the setting of specific characteristic data in the imaging device 1.

FIG. 21 is a flowchart illustrating the processes of the imaging device 1 and the command device 50 when the setting of characteristic data is cancelled. The process of the command device 50 is the process of the CPU 101 based on the setting cancellation instructing process 74. In addition, the process of the imaging device 1 is the process of the controller 40 based on the setting cancellation processing function 64.

In step F701 performed in the command device 50, the operator operating the command device 50 inputs a signal to cancel the setting of specific characteristic data. For example, when the operator selects setting cancellation as an operation menu, the CPU 101 controls the display device 112 to display a list of characteristic data used for setting in the imaging device 1. The operator designates specific characteristic data to be cancelled from the list.

When a command to cancel the setting of specific characteristic data is input, the CPU 101 generates setting cancellation information in step F702.

The setting cancellation information includes, for example, an information type, a setting ID, and a setting unit number, as shown in FIG. 19B.

The setting cancellation information is determined by the information type.

In addition, specific characteristic data to be cancelled is designated by the setting ID and the setting unit number.

When the setting cancellation information is generated, the CPU 101 transmits the setting cancellation information to the communication unit 103 and controls the communication unit 103 to transmit the setting cancellation information to the imaging device 1 in step F703.

In the imaging device 1 receiving the setting cancellation information, the controller 40 performs processes subsequent to step F601 on the basis of the setting cancellation processing function 64.

When received information is acquired by the processes of the communication unit 34 and the received data processing unit 43, the controller 40 determines that the received information is setting cancellation information according to the information type, and the process of the controller 40 proceeds from step F601 to step F602 on the basis of the setting cancellation processing function 64.

In step F602, the controller 40 determines characteristic data to be cancelled on the setting ID and the setting unit number designated in the setting cancellation information and cancels the setting of the characteristic data. For example, as shown in FIG. 10, the controller 40 deletes corresponding characteristic data among the characteristic data registered in the characteristic data setting area of the memory unit 41.

For example, as shown in FIG. 19B, when a setting ID ‘XX’ and a setting unit number ‘1’ are designated, characteristic data of setting number S#1 in FIG. 10 is selected. Therefore, the characteristic data of the setting number S#1, that is, information indicating ‘a person wearing green clothes’ is deleted.

When the characteristic data registered in the characteristic data setting area is deleted, the deleted characteristic data is not related to a target detected by the image analyzing unit 32 or the sound analyzing unit 38 in a subsequent image capturing process.

In step F603, the controller 40 performs a process of notifying the user (policeman) that the setting of characteristic data is cancelled. That is, the controller 40 controls the sound output unit 14 to output an electronic sound or a message sound indicating the reception of the notice, or the controller 40 controls the non-sound notifying unit 35 to operate the vibrator to notify the setting cancellation.

In step F604, the controller 40 transmits information on the cancelled content to the display data generating unit 44 and controls the display data generating unit 44 to generate display data. Then, the controller 40 controls the display unit 11 to perform display. For example, as shown in FIG. 20B, the display unit 11 displays the cancelled content. When the notice indicating that the setting of characteristic data is cancelled in step F603 is received, the policeman having the imaging device 1 can see which characteristic data is cancelled through the image displayed on the display unit 11.

The setting cancellation information transmitted from the command device 50 may include command information in addition to the information shown in FIG. 19B, or it may include notice information related to the cancellation of the setting of characteristic data. For example, the reason for the cancellation of the setting of characteristic data is described as a comment. In this case, in the imaging device 1, the controller 40 controls the display unit 11 to display the content of the comment. For example, when a comment indicating that ‘a person wearing green clothes was taken into protective custody’ is displayed on the imaging device 1, the policeman on the spot can take an action referring to the comment.

9. Reproduction Process

In the imaging device 1, the recording/reproduction processing unit 33 records an image file during image capture. However, as described above, when target image data is detected, the recording/reproduction processing unit 33 generates mark information indicating the address of an image file corresponding to the target image data and registers the mark information onto the mark file. That is, the image file and the mark file are registered on the memory card 5.

The image recorded on the memory card 5 is an image captured during patrol, and the image is reproduced later to identify a person or an article. For example, the policeman operates the imaging device 1 to reproduce the memory card 5 after patrol. Alternatively, the police staff receives the memory card 5 from the policeman and loads the memory card into the memory card slot 114 of the command device 50 to reproduce an image file or an audio file recorded on the memory card 5.

The imaging device 1 and the command device 50 can reproduce an image file or an audio file recorded on the memory card 5 on the basis of a mark file.

FIG. 22 is a flowchart illustrating a reproduction process that is performed by the controller 40 of the imaging device 1 on the basis of the mark image reproducing function 65. The process shown in FIG. 22 is also performed by the CPU 11 of the command device 50 on the basis of the mark image reproducing function 75.

In the following description, the process shown in FIG. 22 is performed by the controller 40 of the imaging device 1. However, the process shown in FIG. 22 may also be performed by the CPU 101 of the command device 50.

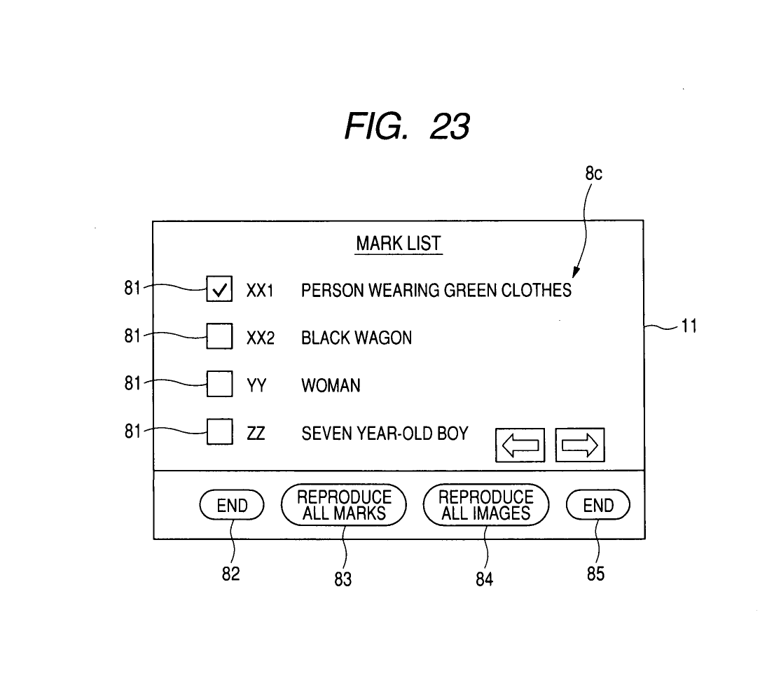

When the operating unit 15 is operated to reproduce an image or audio file recorded on the memory card 5, the process of the controller 40 proceeds from step F801 to F802 and the controller 40 instructs the recording/reproduction processing unit 33 to read a mark file. When the information of the mark file reproduced by the recording/reproduction processing unit 33 is read, the controller 40 displays a mark list in step F803. That is, the controller 40 transmits each mark information item included in the mark file to the display data generating unit 44 and controls the display data generating unit 44 to generate display data as a mark list. Then, the controller 40 controls the display unit 11 to display the mark list, as shown in FIG. 23.

In the mark file shown in FIG. 23, each mark information item included in the mark file is associated with corresponding characteristic data, thereby making a mark list for every characteristic data.

On a list screen 80, each characteristic data is listed up with the setting ID, the setting unit number, and the comment being displayed, and a check box 81 is provided for every characteristic data.

In addition, for example, a reproducing button 82, an all-mark reproducing button 83, an all-image reproducing button 84, and an end button 85 are displayed on the list screen 80.

As viewing the displayed screen, the user of the imaging device 1 can know which characteristic data is marked and designate a reproduction method.

Any of the following methods can be used as the reproduction method: a method of sequentially reproducing all images recorded; a mark point reproduction method of sequentially reproducing all of the marked images; and a target designation reproduction method of reproducing only the image related to designated characteristic data.

The controller 40 waits for the user to designate the reproduction method in step F804.

When the user operates the operating unit to designate the all-image reproducing button 84 on the displayed screen, the controller 40 performs step F805 to instruct the recording/reproduction processing unit 33 to reproduce all image files. In this case, the recording/reproduction processing unit 33 sequentially reproduces all the image files recorded on the memory card 5, not limited to the marked files. For example, the image files FL1 and FL2 captured during patrol are all reproduced. When moving pictures are recorded, all image files are reproduced from the head. The reproduced image is displayed on the display unit 11.

When the user performs an operation of designating the all-mark reproducing button 83 on the displayed screen, the controller 40 performs step F806 and controls the recording/reproduction processing unit 33 to reproduce an image file marked according to the mark file.

In this case, all the image data having addresses on the memory card 5 registered on the mark file as mark information in the mark file shown in FIG. 14 are sequentially reproduced. Therefore, all the image files that are recorded as target image data so as to be associated with characteristic data are sequentially reproduced and displayed on the display unit 11, which makes it possible for the user to view only the image corresponding to the characteristic data.

When the user performs an operation of designating the reproduction button 82 on the displayed screen with the check button 81 of specific characteristic data being turned on, the controller 40 executes step F807 and controls the recording/reproduction processing unit 33 sequentially reproduces only the image files that are marked to correspond to the designated characteristic data (designated target reproduction).

For example, as shown in FIG. 23, when ‘a person wearing green clothes’ is selected, only the image files having a setting ID ‘XX’ and a setting unit number ‘1’ are extracted from the mark file shown in FIG. 14, sequentially reproduced, and displayed on the display unit 11. When the user wants to see the image related to ‘a person wearing green clothes’, the user can view only the image files that are marked so as to correspond to the detection of a person wearing green clothes among recorded images, which makes it unnecessary for the user to sequentially view all the recorded images.

10. Effects of the Invention and Modifications of the Invention

In the command system according to the above-described embodiment, for example, the policeman on patrol has the imaging device 1, and the imaging device 1 captures images at predetermined time intervals and records image files on the memory card 5. Alternatively, the imaging device 1 captures moving pictures and continuously records image files on the memory card 5.

Characteristic data of on object to be searched (target) is set in the imaging device 1 on the basis of the characteristic setting information transmitted from the command device 50. The imaging device 1 analyzes captured image data and detects target image data corresponding to the set characteristic data.

When the target image data is detected, mark information for identifying the target image data among the recorded image data is recorded. For example, the mark information indicates the recording position (for example, an address on the memory card 5) of the target image data. When the memory card 5 is reproduced, the mark information is used to select, extract, and reproduce the target image data.

When the target image data is detected, the imaging device 1 transmits the target image data and target detection notice information including current position information to the command device 50. The command device 50 displays the content of the target detection notice information, which makes it possible for the police staff to view the content of the received information, that is, the target image data or the place where the image is captured. Then, the police staff issues a command to the policeman on the spot on the basis of the content of the received information. That is, the command device 50 transmits command information to the imaging device 1. Then, the imaging device 1 displays the content of the command information to the policeman having the imaging device 1.

In the above-described embodiment, the command device 50 issues a command to set characteristic data for a person or an article to be searched to the imaging device 1. Therefore, the command device 50, that is, the headquarters, such as the police station, can transmit characteristic setting information to a plurality of imaging devices 1, as needed, and collect information from each of the imaging devices 1.

The policeman having the imaging device 1 does not need to manually set characteristic data, and image capture or the transmission of target detection notice information is automatically performed. Therefore, the policeman can simply operate the imaging device, and thus the imaging device 1 is suitable for use during patrol.

When target image data corresponding to characteristic data is detected, it is possible to detect a person or an article to be searched using a captured image, without depending on only the memory or attentiveness of a policeman on the spot. For example, even when the policeman vaguely remembers the characteristic of a person to be searched, the policeman does not clearly determine the person, the policeman forgets to search the person, or the policeman does not recognize a person to be searched, the policeman on patrol can obtain information on a person to be searched who stays around of the policeman.

Since the imaging device 1 displays the detected target image data, the policeman having the imaging device 1 can easily recognize a person to be searched.

The command device 50 having received the target detection notice information displays target image data or positional information of the place where the image is captured, which makes it possible for the police staff to reliably determine whether the displayed person is an object to be searched and to check the position of the person and the date and time where the image of the person is captured. The command device 50 can check the target image data or the place and the date and time where the image is captured and transmit command information to the spot, thereby instructing the policeman to take appropriate actions.

In this way, it is possible to realize an advanced search performance.

When the command device 50 receives target detection notice information and then issues a command, command information may be transmitted to the imaging device 1, which is a source transmitting the target detection notice information. However, positional information (for example, information on subcounty, town, and city names, or information on a specific place) or command information including a comment to require a support may also be transmitted to other imaging devices 1, which is suitable for commanding all search operations.

The policeman having the imaging device 1 can know that characteristic data is set, target image data is detected, a command is received, or the setting of characteristic data is cancelled through a sound output from the sound output unit 14 of the imaging device 1 or vibration generated by the non-sound notifying unit 35 of the imaging device. In this case, the policeman can see the content of the notice displayed on the display unit 11 and take appropriate action corresponding to the content.

Therefore, it does not matter when the policeman vaguely remembers the characteristic of a person to be searched, or the policeman does not need to be concentrated on only the search of a missing person or a wanted criminal, which results in a reduction in stress. The policeman on patrol can accurately search a person or an article while taking various actions such as the observation of a police district for maintaining the public peace and the guidance of persons.

In this embodiment, the display unit 11 displays the content of a comment and the content of information on the setting of characteristic data or the cancellation thereof included in command information, but the invention is not limited thereto. For example, the content of the comment or the content of the information may be output as a sound from the sound output unit 14. That is, the contents may be output such that the user of the imaging device 1 can recognize the output of the contents.

The imaging device 1 cancels the setting of the characteristic data on the basis of the setting cancellation information transmitted from the command device 50. That is, the command device 50 can instruct the imaging device 1 to cancel the setting of characteristic data when a case is settled or search for a person or an article ends. Therefore, the policeman using the imaging device 1 does not need to perform a setting cancellation operation and can cancel the setting of characteristic data at an appropriate time, which results in a simple detection process.

In particular, when an object to be searched appears, characteristic data for the object to be searched is simultaneously set to a plurality of imaging devices 1 attached to policeman in different places, which is preferable for search.

When a criminal is arrested or a mission person is taken into protective custody and thus the search is completed, it is desirable that the setting of the characteristic data for the object to be searched be simultaneously cancelled in a plurality of imaging devices 1.

As described in this embodiment, the setting and cancellation of the characteristic data are performed on the basis of the characteristic setting information and setting cancellation information transmitted from the command device 50, respectively, which makes it possible to easily set or cancel the characteristic data to or from a plurality of imaging devices 1.

The user may operate a corresponding one of the imaging devices 1 to set the characteristic data or cancel the characteristic data in each imaging device 1.

In the marking process of target image data, a mark file having mark information registered thereon may be recorded on the memory card 5 beforehand, and a captured image may be effectively checked when an image file or an audio file recorded on the memory card 5 is reproduced. For example, since only a marked image can be reproduced or only an image corresponding to selected characteristic data can be reproduced, the user can effectively reproduce a desired image and view the reproduced image. In addition, it is possible to prevent target image data from being missed during reproduction.

In the above-described embodiment, in the imaging device 1, the recording/reproduction processing unit 33 generally performs recording in the first recording mode, and performs recording in the second recording mode in order to detect target image data.

A larger amount of information is recorded in the second mode than in the first recording mode.

Since target image data is recorded in the second recording mode, an effective image for search is recorded in a recording mode capable of recording a large amount of information. A general image that is not important is recorded in the first recording mode capable of recording a small amount of information.

Therefore, only an important image is composed of high-quality of image data by effectively using storage capacity of the memory card 5 serving as a recording medium.

The target image data is transmitted to the command device 50 to be displayed, or it is reproduced on the basis of mark information and is then displayed. Therefore, the policeman on the spot or the police staff in the police station can carefully view the content of the target image data. Thus, the target image data may be composed of image data having a large amount of information.

Actually, various recording operations may be performed in the first recording mode and the second recording mode. In the above-described embodiment, a still picture is recorded at a high compression ratio in the first mode, and a still picture is recorded at a low compression ratio in the second mode. Therefore, the second mode records a higher-quality image than the first recording mode. However, the invention is not limited thereto. For example, the first recording mode and the second recording mode may be used as follows.

(1) Still pictures are recorded in the first recording mode at a predetermined time interval, and moving pictures are recorded in the second recording mode.

(2) Still pictures are recorded in the first recording mode at a time interval of N seconds, and moving pictures are recorded in the second recording mode at a time interval of M seconds (N>M).

(3) Moving pictures are recorded at a high compression ratio in the first recording mode, and moving pictures are recorded at a low compression ratio in the second recording mode.

(4) Moving pictures having a small number of frames of images are recorded in the first recording mode, and moving pictures having a large number of frames of images are recorded in the second recording mode.

(5) A small number of frames of still pictures are recorded in the first recording mode, and moving pictures having a large number of frames of images are recorded in the second recording mode.

(6) A small number of frames of still pictures are recorded in the first recording mode, and a large number of frames of still pictures are recorded in the second recording mode.

(7) Moving pictures are recorded at a low frame rate in the first recording mode, and moving pictures are recorded at a high frame rate in the second recording mode. The frame rate is the number of frames per unit time.

(8) Moving pictures are recorded at a high compression ratio and a low frame rate in the first recording mode, and moving pictures are recorded at a low compression ratio and a high frame rate in the second recording mode.

For example, a difference in the amount of information to be recorded may be provided in accordance with the type of images, such as a still picture or a moving picture, a compression ratio, the number of frames of images, the frame rate of moving pictures, the time interval between still pictures, or a combination thereof, and a larger amount of information may be recorded in the second recording mode.

A recording operation which is not divided into the first and second recording modes, that is, a recording operation which does not switch a recording mode during image capture may be performed.

In the above-described embodiment, a color is used as an example of characteristic data, and the image analyzing unit 32 detects the image of a person or an article having a color corresponding to characteristic data as target image data, but the characteristic data is not limited to a color. For example, the characteristic data may be data indicating the characteristic of a person or an article in appearance, data indicating the movement of a person or an article, or data indicating a specific sound.

The characteristic of a person or an article in appearance includes, for example, the height of a person, the color of the skin, person's belongings, such as a bag, the number of persons, and the type of cars, in addition to the color, which are also set as characteristic data. That is, any factors may be used as the characteristic data as long as the images thereof can be analyzed by the image analyzing unit 32.

When the movement of a person or an article is used as characteristic data, for example, a running person or a car traveling in zigzag may be set as the characteristic data. The image analyzing unit 32 can detect the movement of a person or an article by comparing frames of moving picture data.

In the case of data indicating a specific sound, a specific sound, such as an alarm or a siren, a keyword, a voiceprint, or a shout may be set as characteristic data. The sound analyzing unit 38 detects these sounds to determine whether a target is detected. When the sound analyzing unit 38 detects a target, image data captured at that time becomes target image data.

An AND condition and an OR condition may be set to the characteristic data, and one characteristic data may designate a plurality of persons or articles. For example, characteristic data indicating ‘a person wearing navy blue clothes and a person wearing blue clothes’ may be set to two persons.

In the above-described embodiment, the command system is used for the police and guard, but the invention is not limited thereto. For example, the command system may be applied to other purposes.

For example, the command system may be used to search a mission child in a public place or an amusement park.

A program according to an embodiment of the invention can allow the controller 40 of the imaging device 1 to execute the processes shown in FIGS. 8, 12, 18, 21, and 22. That is, the program allows the controller 40 of the imaging device 1 to execute the characteristic data setting function 61, the imaging process control function 62, the command information processing function 63, the setting cancellation processing function 64, and the mark image reproducing function 65 shown in FIG. 7A.

Further, a program according to an embodiment of the invention can allow the CPU 101 of the command device 50 to execute the processes shown in FIGS. 8, 17, 21, and 22. That is, the program allows the CPU 101 of the command device 50 to execute the characteristic setting information generating function 71, the target detection notice correspondence function 72, the command processing function 73, the setting cancellation instructing function 74, and the mark image reproducing function 75 shown in FIG. 7B.

These programs may be stored in a system HDD, serving as a recording medium of an information processing apparatus, such as a computer system, or in a ROM of a microcomputer having a CPU beforehand.

Alternatively, these programs may be temporarily or permanently stored (recorded) in a removable recording medium, such as a flexible disc, a CD-ROM (compact disc read only memory), an MO (magnet optical) disc, a DVD (digital versatile disc), a magnetic disc, or a semiconductor memory. The removable recording medium can be provided as package software. For example, these programs may be provided by the CD-ROM or DVD ROM and then installed in a computer system.

These programs may be may be downloaded from a download server to the computer system through a network, such as a LAN (local area network) or the Internet, in addition to being installed from the removable recording medium.

It should be understood by those skilled in the art that various modifications, combinations, sub-combinations and alterations may occur depending on design requirements and other factors insofar as they are within the scope of the appended claims or the equivalents thereof.

What is claimed is:

1. A command system comprising:
a portable imaging device; and
a command device configured to communicate with the imaging device,
wherein the imaging device includes
an imaging unit configured to perform image capture to acquire image data;
a communication unit configured to communicate with the command device;
a characteristic data setting unit configured to set characteristic data on the basis of characteristic setting information transmitted from the command device;
a target image detecting unit configured to analyze the image data acquired by the imaging unit and detect target image data corresponding to the set characteristic data;
a recording unit configured to record the image data acquired by the imaging unit on a recording medium; and
an imaging process control unit configured, when the target image data is detected by the target image detecting unit, to record mark information for identifying the target image data among the image data recorded by the recording unit, and
the command device includes
a communication unit configured to communicate with the imaging device; and
a characteristic setting information generating unit configured to generate the characteristic setting information for setting the characteristic data and control the communication unit to transmit the characteristic setting information to the imaging device.

2. A portable imaging device that is configured to communicate with a command device, comprising:
an imaging unit configured to perform image capture to acquire image data;
a communication unit configured to communicate with the command device;
a characteristic data setting unit configured to set characteristic data on the basis of characteristic setting information transmitted from the command device;
a target image detecting unit configured to analyze the image data acquired by the imaging unit and detect target image data corresponding to the set characteristic data;
a recording unit configured to record the image data acquired by the imaging unit on a recording medium; and
an imaging process control unit configured, when the target image data is detected by the target image detecting unit, to record mark information for identifying the target image data among the image data recorded by the recording unit.

3. The portable imaging device according to claim 2, further comprising:
a presentation unit configured to present information,
wherein the characteristic data setting unit controls the presentation unit to present the content of the characteristic data set on the basis of the characteristic setting information.

4. The portable imaging device according to claim 2,
wherein the characteristic data is data indicating the characteristic of an article or a person in appearance, data indicating the movement of the article or the person, or data indicating a specific sound.

5. The portable imaging device according to claim 2, further comprising:
a sound input unit,
wherein the target image detecting unit analyzes audio data obtained by the sound input unit, and
when audio data corresponding to the set characteristic data is detected, the target image detecting unit detects the target image data, considering as the target image data the image data obtained by the imaging unit at the timing at which the audio data is input.

6. The portable imaging device according to claim 2,
wherein, when the target image data is detected by the target image data detecting unit, the imaging process control unit generates target detection notice information and controls the communication unit to transmit the target detection notice information to the command device.

7. The portable imaging device according to claim 6,
wherein the target detection notice information includes the target image data.

8. The portable imaging device according to claim 6, further comprising:
a position detecting unit configured to detect positional information,
wherein the target detection notice information includes the positional information detected by the position detecting unit.

9. The portable imaging device according to claim 2, further comprising:
a display unit configured to display information,
wherein, when the target image data is detected by the target image detecting unit, the imaging process control unit controls the display unit to display an image composed of the target image data.

10. The portable imaging device according to claim 2,
wherein the imaging process control unit controls the recording unit to start recording the image data in a first recording mode, and
when the target image data is detected by the target image detecting unit, the imaging process control unit controls the recording unit to record the image data in a second recording mode.

11. The portable imaging device according to claim 2, further comprising:
a presentation unit configured to present information; and
a command information processing unit configured, when the communication unit receives command information from the command device, to control the presentation unit to present the content of the command information.

12. The portable imaging device according to claim 2, further comprising:
a setting cancellation processing unit configured, when the communication unit receives setting cancellation information from the command device, to cancel the setting of the characteristic data indicated by the setting cancellation information.

13. The portable imaging device according to claim 2, further comprising:
a reproduction unit configured to reproduce the image data recorded on the recording medium; and
a mark image reproduction control unit configured to control the reproduction unit to reproduce the image data, serving as the target image data, on the basis of the mark information.

14. A command device that is configured to communicate with an imaging device, comprising:
a communication unit configured to communicate with the imaging device; and
a characteristic setting information generating unit configured to generate characteristic setting information for setting characteristic data and control the communication unit to transmit the characteristic setting information to the imaging device.

15. The command device according to claim 14,
wherein the characteristic data is data indicating the characteristic of an article or a person in appearance, data indicating the movement of the article or the person, or data indicating a specific sound.

16. The command device according to claim 14, further comprising:
a presentation unit configured to present information; and
a target detection notice correspondence processing unit configured, when the communication unit receives target detection notice information from the imaging device, to control the presentation unit to present information included in the received target detection notice information.

17. The command device according to claim 14, further comprising:
a command processing unit configured to generate command information and control the communication unit to transmit the command information to the imaging device.

18. The command device according to claim 14, further comprising:
a setting cancellation instructing unit configured to generate setting cancellation information for canceling the characteristic data set in the imaging device and control the communication unit to transmit the setting cancellation information to the imaging device.

19. The command device according to claim 14, further comprising:
a reproduction unit configured to reproduce a recording medium having image data and mark information for identifying target image data of the image data recorded thereon in the imaging device; and
a mark image reproduction control unit configured to control the reproduction unit to reproduce the image data, serving as the target image data, on the basis of the mark information.

20. An imaging method of a portable imaging device that is configured to communicate with a command device, the method comprising the steps of:
setting characteristic data on the basis of characteristic setting information transmitted from the command device;
performing image capture to acquire image data;
recording the acquired image data on a recording medium;
analyzing the acquired image data to detect target image data corresponding to the set characteristic data; and
when the target image data is detected, recording mark information for identifying the target image data among the recorded image data.

21. The imaging method according to claim 20, further comprising:
when the target image data is detected, generating target detection notice information and transmitting the target detection notice information to the command device.

22. The imaging method according to claim 21, further comprising:
when command information is received from the command device, presenting the content of the command information.

23. A command processing method of a command device that is configured to communicate with an imaging device, the method comprising the steps of:
generating characteristic setting information for setting characteristic data and transmitting the characteristic setting information to the imaging device;
when target detection notice information is received from the imaging device, presenting information included in the received target detection notice information; and
generating command information and transmitting the command information to the imaging device.

24. A program for allowing a portable imaging device that is configured to communicate with a command device to execute the functions of:
setting characteristic data on the basis of characteristic setting information transmitted from the command device;
performing image capture to acquire image data;
recording the acquired image data on a recording medium;
analyzing the acquired image data to detect target image data corresponding to the set characteristic data; and
when the target image data is detected, recording mark information for identifying the target image data among the recorded image data.

25. The program according to claim 24, allowing the imaging device to further execute the function of:
when the target image data is detected, generating target detection notice information and transmitting the target detection notice information to the command device.

26. The program according to claim 25, allowing the imaging device to further execute the function of:
when command information is received from the command device, presenting the content of the command information.

27. A program for allowing a command device that is configured to communicate with an imaging device to execute the functions of:
generating characteristic setting information for setting characteristic data and transmitting the characteristic setting information to the imaging device;
when target detection notice information is received from the imaging device, presenting information included in the received target detection notice information; and
generating command information and transmitting the command information to the imaging device.
